(19) United States
(12) Patent Application Publication
(10) Pub. No.: US 2025/0011544 A1
(43) Pub. Date: Jan. 9, 2025

(54) PHOTODYNAMIC THIOL-ENE POLYMERIC COMPOSITIONS

(71) Applicant: President and Fellows of Harvard College, Cambridge, MA (US)

(72) Inventors: Kezi Cheng, Cambridge, MA (US); Alex Chortos, Cambridge, MA (US); David Clarke, Cambridge, MA (US)

(73) Assignee: President and Fellows of Harvard College, Cambridge, MA (US)

(21) Appl. No.: 18/708,901

(22) PCT Filed: Nov. 10, 2022
(86) PCT No.: PCT/US2022/049625

§ 371 Date: May 9, 2024

Related U.S. Application Data
(60) Provisional application No. 63/277,981, filed on Nov. 10, 2021.

(51) Int. Cl. C08G 75/12

(52) U.S. Cl. CPC C08G 75/12

(57) ABSTRACT

Described in embodiments herein are thiol-ene polymeric compositions that exhibit photo-induced, reversible switching between a solid (e.g., elastomeric) state and a liquid (e.g., flowable) state. The thiol-ene polymeric compositions may comprise a vinyl oligomer comprising at least two vinyl groups, a thiol oligomer comprising at least two thiol groups, and a Type I photoinitiator. In some embodiments, the composition comprises an excess of thiol groups relative to vinyl groups (e.g., a ratio of thiol groups to vinyl groups in the composition is at least 3:1). Reversible switching between the solid state and the liquid state may be induced through exposure of the composition to electromagnetic radiation (e.g., ultraviolet (UV) radiation). In some cases, reversible switching may be induced by a relatively low amount of energy (e.g., about 1 J/cm2 or less).

### RELATED APPLICATION

This application claims the benefit of priority under 35 U.S.C. § 119(e) of U.S. Provisional Application Ser. No. 63/277,981, filed Nov. 10, 2021, the disclosure of which is incorporated by reference herein in its entirety.

### GOVERNMENT SUPPORT

This invention was made with Government support under Grant No. DMR-20-11754 and Graduate Research Followship No. DGE-1745303 awarded by the National Science Foundation. The Government has certain rights in the invention.

### FIELD

The present invention generally relates to photodynamic thiol-ene polymeric compositions.

### BACKGROUND

Elastomeric materials for applications in soft robotics, conformable electronics, adhesives and consumer products are typically covalently crosslinked polymer networks that, once set, cannot be reprocessed. However, reprocessing is often desirable since it allows for innovative manufacturing processes (including component re-positioning and re-molding) and could potentially address environmental waste concerns by facilitating recycling.

While several covalently crosslinked polymer networks are known to undergo bond cleavage or depolymerization at high temperatures or under specific chemical conditions, these networks often exhibit degradation of mechanical properties and/or require custom synthesis of precursors. As one example, vitrimers are characterized by thermally-activated dynamic bonding, but cooling a vitrimer to room temperature can generate internal stresses that lead to distortion and degradation of mechanical properties. In addition, using temperature to induce dynamic bonding is difficult to control spatially. As another example, covalently crosslinked polymer networks that undergo photo-mediated, reversible cleavage of the backbone to allow chain rearrangement through additional fragmentation chain transfer are known but typically require custom synthesis of precursors, which limits the scalability and generality of the approach.

Accordingly, there is a need for a scalable, cost-effective approach to developing polymers that can undergo reprocessing while maintaining robust mechanical properties.

### SUMMARY

Aspects of the disclosure relate to photodynamic thiol-ene polymeric compositions.

One aspect of the present disclosure relates to a composition. In some embodiments, the composition comprises a vinyl oligomer comprising at least two vinyl groups. In some embodiments, the composition comprises a first thiol oligomer comprising at least two thiol groups. In some embodiments, the composition comprises a Type I photoinitiator.

Another aspect of the present disclosure relates to a method. In some embodiments, the method comprises exposing a composition to an amount of electromagnetic radiation over a first period of time. In certain embodiments, the electromagnetic radiation comprises ultraviolet radiation. In certain embodiments, the composition comprises a vinyl oligomer comprising at least two vinyl groups, a first thiol oligomer comprising at least two thiol groups, and a Type I photoinitiator. In certain embodiments, at least a portion of the composition is in a liquid state during at least a portion of the first period of time. In some embodiments, the method comprises not exposing the composition to the amount of electromagnetic radiation over a second period of time. In some embodiments, the composition is in a solid state during at least a portion of the second period of time.

The details of one or more embodiments of the invention are set forth in the description below. Other features or advantages of the present invention will be apparent from the following drawings and detailed description of several embodiments, and also from the appended claims.

### BRIEF DESCRIPTION OF THE DRAWINGS

Non-limiting embodiments of the present invention are described by way of example with reference to the accompanying figures, which are schematic and are not intended to be drawn to scale unless otherwise indicated. In some embodiments of the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In figures including shading (e.g., FIGS. 2A, 2B, 2C, 3B, 3D, 3F, 3G, 4B, 5B, 6B, 6F, 6I, 6K, 7, 8B, 10D), the shading indicates exposure to ultraviolet (“UV”) illumination.

FIG. 1 shows, according to some embodiments, a schematic illustration of radical-mediated, photo-induced switching of thiol-ene polymeric compositions between a solid (e.g., elastomeric) state and a liquid (e.g., flowable) state.

FIG. 2A shows stress relaxation measurements (i.e., plots of normalized stress as a function of time (s)) demonstrating the generality of photo-induced switching in thiol-ene polymeric compositions using different polymer backbone and vinyl chemistries, according to some embodiments.

FIG. 2B shows stress relaxation measurements (i.e., plots of normalized stress as a function of time (s)) for thiol-ene polymeric compositions comprising divinyl siloxanes of varying molecular weights, according to some embodiments.

FIG. 2C shows images of an embedded steel sphere in a thiol-ene polymeric composition, according to some embodiments. Under UV illumination, the thiol-ene polymeric composition flowed, and the sphere fell under gravity. When the UV illumination was turned off, the thiol-ene polymeric composition solidified and held the sphere in place.

FIG. 3A shows, according to some embodiments, a schematic of exemplary thiol-ene polymeric compositions having constant divinyl content and varying thiol content.

FIG. 3B shows, according to some embodiments, storage modulus G′ (kPa) switching during two cycles of UV exposure for thiol-ene polymeric compositions having varying vinyl:thiol ratios (e.g., by varying amounts of a 4.75-functional thiol oligomer).

FIG. 3C shows, according to some embodiments, storage modulus G′ (kPa) when UV was off (solid state) and change in G′ when UV was turned on for thiol-ene polymeric compositions comprising a divinyl oligomer having a molecular weight of 9.4 kDa, a polyfunctional thiol with 4.75 thiol groups per molecule, and varying thiol:vinyl ratios.

FIG. 3D shows, according to some embodiments, stress relaxation experiments (i.e., plots of normalized stress as a function of time (s)) for thiol-ene polymeric compositions comprising a divinyl oligomer having a molecular weight of 9.4 kDa, a polyfunctional thiol with 4.75 thiol groups per molecule, and varying thiol:vinyl ratios.

FIG. 3E shows, according to some embodiments, a schematic of exemplary thiol-ene polymeric compositions having varying vinyl content (e.g., by varying amounts of a polyfunctional vinyl oligomer) and constant thiol content.

FIG. 3F shows, according to some embodiments, a plot of storage modulus G′ (kPa) as a function of time (s) for thiol-ene polymeric compositions having vinyl:thiol ratios ranging from 1:1 to 20:1.

FIG. 3G shows, according to some embodiments, a plot of loss modulus G″ (kPa) as a function of time (s) for thiol-ene polymeric compositions having vinyl:thiol ratios ranging from 1:1 to 20:1.

FIG. 4A shows a schematic of exemplary thiol-ene polymeric compositions having varying thiol functionality and a constant 1:3 vinyl:thiol ratio, according to some embodiments.

FIG. 4B shows G′ switching while varying the percentage of dithiols to polythiols in thiol-ene polymeric compositions, according to some embodiments.

FIG. 4C shows G′ (kPa) when UV was off (solid state) and the change in G′ when UV was turned on for thiol-ene polymeric compositions comprising a divinyl oligomer having a molecular weight of 9.4 kDa, a thiol:vinyl ratio of 3:1, and different ratios of polyfunctional thiols to dithiols, according to some embodiments.

FIG. 4D shows G′ (kPa, UV off) and viscosity (Pa·s, UV on) as a function of dithiol molar content of thiol-ene polymeric compositions, according to some embodiments.

FIG. 5A shows, according to some embodiments, a schematic of exemplary thiol-ene polymeric compositions having constant 1:3 vinyl:thiol and 3:1 polythiol:dithiol ratios and a varying molecular weight of the divinyl oligomer.

FIG. 5B shows, according to some embodiments, a plot of G′ (kPa) as a function of time (s) demonstrating that G′ switching shows greater switching magnitude for lower molecular weight divinyl oligomers.

FIG. 5C shows, according to some embodiments, G′ (kPa, UV off) and viscosity (Pa·s, UV on) as a function of molecular weight (kDa) of divinyl oligomers in thiol-ene polymeric compositions, according to some embodiments.

FIG. 6A shows a schematic of exemplary thiol-ene polymeric compositions having varying photoinitiators and chemical structures of exemplary Type I and Type II photoinitiators, according to some embodiments.

FIG. 6B shows a plot of G′ (kPa) as a function of time (s) during photo-induced switching of thiol-ene polymeric compositions comprising Type I photoinitiators or Type II photoinitiators, according to some embodiments.

FIG. 6C shows change in G′ when UV is turned on over 9 cycles at an exposure of 100 mW/cm² for 30 seconds for thiol-ene polymeric compositions comprising varying photoinitiators, according to some embodiments.

FIG. 6D shows G′ (kPa), on a logarithmic scale, as a function of cycle number and exposure dose (J/cm²) for 24 UV cycles for thiol-ene polymeric compositions comprising varying photoinitiators, a divinyl oligomer with a 9.4 kDa molecular weight, a vinyl:thiol ratio of 1:3, and a polythiol:dithiol ratio of 3:1, according to some embodiments.

FIG. 6E shows G′ (kPa), on a linear scale, as a function of cycle number and exposure dose (J/cm²) for 10 UV cycles for thiol-ene polymeric compositions comprising varying photoinitiators, a divinyl oligomer with a 9.4 kDa molecular weight, a vinyl:thiol ratio of 1:3, and a polythiol:dithiol ratio of 3:1, according to some embodiments.

FIG. 6F shows a plot of G′ (kPa) as a function of time (s) during photo-induced switching for thiol-ene polymeric compositions comprising varying concentrations of HMPP photoinitiator, according to some embodiments.

FIG. 6G shows G′ (kPa) as a function of cycle number and exposure dose (J/cm²) for 10 UV cycles for thiol-ene polymeric compositions comprising varying concentrations of HMPP photoinitiator, a divinyl oligomer with a 9.4 kDa molecular weight, a vinyl:thiol ratio of 1:3, and a polythiol:dithiol ratio of 3:1, according to some embodiments.

FIG. 6H shows change in G′ as a function of cycle number and exposure dose (J/cm²) for 10 UV cycles for thiol-ene polymeric compositions comprising varying concentrations of HMPP photoinitiator, a divinyl oligomer with a 9.4 kDa molecular weight, a vinyl:thiol ratio of 1:3, and a polythiol:dithiol ratio of 3:1, according to some embodiments.

FIG. 6I shows a plot of G′ (kPa) as a function of time (s) demonstrating that adding additional photoinitiator after 15 cycles of UV switching at 16.7 mW/cm² recovered and enhanced switching behavior, according to some embodiments.

FIG. 6J shows photo-induced change in G′ after 15 cycles with 60 μmol/cm³ of HMPP (square) and after adding an additional 60 μmol/cm³ of HMPP (circle) for thiol-ene polymeric compositions comprising a divinyl oligomer with a 9.4 kDa molecular weight, a vinyl:thiol ratio of 1:3, and a polythiol:dithiol ratio of 3:1, according to some embodiments.

FIG. 6K shows a plot of G′ (kPa) as a function of time (s) under exposure to broadband radiation, radiation having a wavelength of 290-400 nm, and radiation having a wavelength of 400-500 nm for thiol-ene polymeric compositions comprising a vinyl oligomer having a molecular weight of 14 kDa, a vinyl:thiol ratio of 1:3, a polythiol:dithiol ratio of 2:1, and 1 wt % of HMPP photoinitiator, according to some embodiments.

FIG. 7 shows, according to some embodiments, viscosity measurements at UV intensities of 3.65, 7.06, 16.8, and 48.0 mW/cm² for thiol-ene polymeric compositions comprising a divinyl oligomer having a molecular weight of 9.4 kDa, a vinyl:thiol ratio of 1:3, and a polythiol:dithiol ratio of 3:1.

FIG. 8A shows a schematic of cycle testing, which consisted of a series of stress relaxation measurements at 20% strain with a UV exposure time of 10 seconds, according to some embodiments. All measurements were conducted using thiol-ene polymeric compositions comprising a divinyl oligomer having a molecular weight of 9.4 kDa, a vinyl:thiol ratio of 1:3, and a polythiol:dithiol ratio of 3:1.

FIG. 8B shows cycles 5 and 100 of the stress relaxation measurements of FIG. 8A at UV intensities of 3.65 and 100 mW/cm², according to some embodiments.

FIG. 8C shows time constants as a function of cycle number for the stress relaxation measurements of FIG. 8A, according to some embodiments. The solid lines are a linear fit to the data.

FIG. 9A shows, according to some embodiments, shear dynamic mechanical analysis demonstrating Maxwellian behavior when exposed to 16.7 mW/cm² UV. The slope of G′=2 and G″=1 before G″ crosses G′ indicate chemically or physically un-crosslinked polymers.

FIG. 9B shows, according to some embodiments, shear modulus (kPa) as a function of temperature (° C.).

FIG. 9C shows, according to some embodiments, stress-strain data showing minimal hysteresis and plastic deformation up to strains of 100%, according to some embodiments.

FIG. 9D shows, according to some embodiments, constant strain measurements in a photo-rheometer.

FIG. 9E shows, according to some embodiments, creep measurements of a thiol-ene polymeric composition comprising a divinyl oligomer having a molecular weight of 9.4 kDa, a vinyl:thiol ratio of 1:3, and a polythiol:dithiol ratio of 3:1.

FIG. 10A shows stress-strain curves demonstrating that as cast and cut/healed thiol-ene polymeric compositions (comprising a divinyl oligomer having a molecular weight of 14 kDa, a vinyl:thiol ratio of 1:3, and a polythiol:dithiol ratio of 3:1) showed high healing efficiency post-60-second UV-assisted healing, according to some embodiments.

FIG. 10B shows hysteresis of cut and healed elastomer v. pristine elastomer (comprising a divinyl oligomer having a molecular weight of 14 kDa, a vinyl:thiol ratio of 1:3, a polythiol:dithiol ratio of 3:1, and 1 wt % of HMPP photoinitiator), according to some embodiments.

FIG. 10C shows stress measured at 1 mm/s strain rate for thiol-ene polymeric compositions exposed to UV and no UV, according to some embodiments. The thiol-ene polymeric composition sagged as it was stretched under UV exposure.

FIG. 10D shows mechanical response as a thiol-ene polymeric composition was stretched at a constant displacement rate of 5 mm/s, with the thiol-ene polymeric composition exhibiting elastic behavior until UV illumination was turned on, according to some embodiments. After UV was turned on, the composition elongated faster than it was being extended as it also deformed under gravity. The thiol-ene polymeric composition comprised a divinyl oligomer having a molecular weight of 14 kDa, a vinyl:thiol ratio of 1:3, a polythiol:dithiol ratio of 3:1, and 1 wt % of HMPP photoinitiator.

FIG. 10E shows peeling force (N/m) as a function of clamp distance (mm) where thiol-ene polymeric compositions (comprising a divinyl oligomer having a molecular weight of 9.4 kDa, a vinyl:thiol ratio of 1:3, and a polythiol:dithiol ratio of 3:1) on polyethylene (PE) substrates (20 μm) were peeled apart, according to some embodiments. When UV light of 100% intensity was applied, necking of the thiol-ene polymeric composition was observed.

FIG. 10F shows photo-induced patterning of a thiol-ene polymeric composition, according to some embodiments.

FIG. 10G shows photo-induced repatterning of the same thiol-ene polymeric composition as shown in FIG. 10F, according to some embodiments. Repeatable patterning and repatterning of thiol-ene polymeric compositions on quarter coins having different surface engravings showed high resolution of the imprinted features.

### DETAILED DESCRIPTION

Described in embodiments herein are thiol-ene polymeric compositions that exhibit photo-induced, reversible switching between a solid (e.g., elastomeric) state and a liquid (e.g., flowable) state. The thiol-ene polymeric compositions may comprise a vinyl oligomer comprising at least two vinyl groups, a thiol oligomer comprising at least two thiol groups, and a Type I photoinitiator. In some embodiments, the composition comprises an excess of thiol groups relative to vinyl groups (e.g., a ratio of thiol groups to vinyl groups in the composition is at least 3:1). Reversible switching between the solid state and the liquid state may be induced through exposure of the composition to electromagnetic radiation (e.g., ultraviolet (UV) radiation). In some cases, reversible switching may be induced by a relatively low amount of energy (e.g., about 1 J/cm² or less).

Polymers that can undergo reprocessing (e.g., through reversible switching between a solid state and a liquid state) may be useful in a wide range of applications, including manufacturing, recycling, consumer products (e.g., bondable and debondable adhesives, conformable wearables, remoldable devices), and photo-mediated damage recovery and healing. Surprisingly, it has been found that photo-induced excitation (i.e., excitation through exposure to electromagnetic radiation) of thiol-ene polymeric compositions can induce fast, reversible switching between a solid state (e.g., an elastomeric state) and a liquid state (e.g., a flowable state). A thiol-ene polymeric composition generally refers to a polymeric composition comprising at least one thiol group and at least one alkene (e.g., at least one vinyl group). A thiol-ene polymeric composition that undergoes reversible photo-induced switching may be referred to as a photodynamic or photo-switchable composition. Without wishing to be bound by a particular theory, photo-induced switching of thiol-ene polymeric compositions may be attributed to the sulfide bonds formed during thiol-ene polymerization.

Thiol-ene polymeric compositions described herein may be associated with a number of advantages. For example, thiol-ene polymeric compositions described herein may be prepared with a wide range of vinyl oligomers (e.g., a wide range of backbone chemistries, a wide range of vinyl group chemistries), many of which may be commercially available. In some cases, one or more additional components of the thiol-ene polymeric compositions (e.g., a thiol oligomer, a Type I photoinitiator) may also be commercially available. Thus, thiol-ene polymeric compositions may represent a general, cost-effective approach that can be used with a wide range of commercially available precursors. This may advantageously avoid the need for custom synthesis of precursors, which may be expensive and/or time consuming.

In some cases, switching of the thiol-ene polymeric compositions may be induced by exposure to a relatively small amount of electromagnetic radiation. In certain cases, for example, photo-induced switching of thiol-ene polymeric compositions may require less energy than thermally activated switching of vitrimers. The low energy requirements for reversible switching of thiol-ene polymeric compositions may advantageously reduce costs associated with polymer switching and may make the thiol-ene polymeric compositions attractive for low-energy manufacturing applications.

In some cases, the thiol-ene polymeric compositions are stable over a wide range of temperatures, and photo-induced switching of the compositions may occur at any suitable temperature. In some instances, for example, photo-induced switching between a solid state and a liquid state of a thiol-ene polymeric composition may occur at approximately room temperature. Thus, reversible switching of thiol-ene polymeric compositions may represent a flexible approach to polymer reprocessing that does not require applying heat to compositions.

In some cases, photo-induced switching of thiol-ene polymeric compositions may be highly spatially controlled. In certain embodiments, a beam of electromagnetic radiation may be precisely controlled to spatially expose one or more portions of a sheet or block of the thiol-ene polymeric composition to electromagnetic radiation. In some such embodiments, one or more portions of the composition may undergo reversible switching while one or more other portions of the composition may remain unexposed to the electromagnetic radiation and may not undergo reversible switching. In other embodiments, an entire thiol-ene polymeric composition may be exposed to electromagnetic radiation such that the entire polymeric composition undergoes reversible switching. In some cases, therefore, photodynamic thiol-ene polymeric compositions may allow enhanced spatial control of switching (e.g., relative to thermally activated polymeric compositions).

In some cases, photo-induced switching of thiol-ene polymeric compositions may be relatively fast. In some instances, exposure of a thiol-ene polymeric composition in a solid state to electromagnetic radiation (e.g., UV radiation) may advantageously induce nearly complete stress relaxation in a relatively short period of time (e.g., on the order of seconds).

In some cases, thiol-ene polymeric compositions in a solid state may be mechanically robust even after one or more cycles of reversible switching. In some instances, for example, a thiol-ene polymeric composition in a solid state may advantageously exhibit low hysteresis and/or low creep after one or more cycles of reversible switching.

### Exemplary Thiol-Ene Polymeric Composition

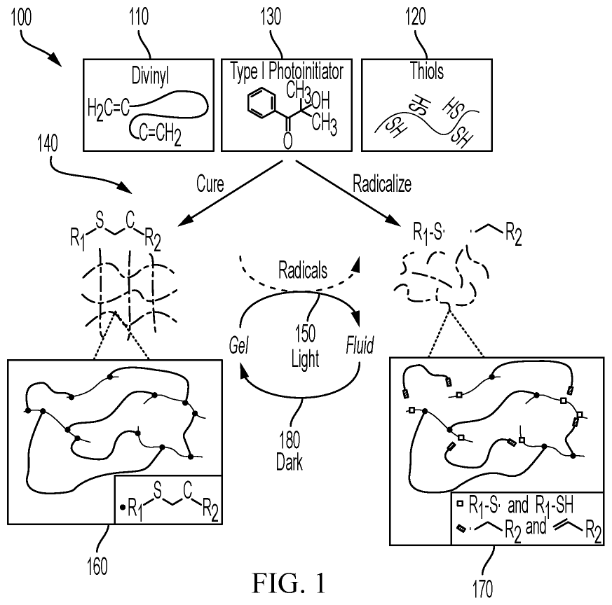

FIG. 1 is a schematic illustration of an exemplary thiol-ene polymeric composition 100. As shown in FIG. 1, composition 100 may comprise vinyl oligomer 110 (e.g., a divinyl oligomer), thiol oligomer 120, and Type I photoinitiator 130. Upon curing of composition 100 (indicated by arrow 140), one or more thiol groups of thiol oligomer 120 and one or more vinyl groups of vinyl oligomer 110 may react to form one or more sulfide bonds, and composition 100 may form a solid elastomer. Upon subsequent exposure to an amount of electromagnetic radiation (indicated by arrow 150), composition 100 may switch from solid (e.g., elastomeric) state 160 to liquid (e.g., flowable) state 170. In liquid state 170, composition 100 may flow as a viscous liquid. Upon termination of exposure to the amount of electromagnetic radiation (indicated by arrow 180), composition 100 may switch from liquid state 170 to solid state 160. In solid state 160, composition 100 may stop flowing.

### Vinyl Oligomer

In some embodiments, a thiol-ene polymeric composition comprises a vinyl oligomer comprising at least two vinyl groups. As used herein, a “vinyl group” refers to any functional group comprising a carbon-carbon double bond. Non-limiting examples of suitable vinyl groups include allyl, vinyl ether, and acrylate groups. Each of the at least two vinyl groups of the vinyl oligomer may independently be any suitable vinyl group (i.e., the at least two vinyl groups may be the same or different). Each of the at least two vinyl groups of the vinyl oligomer may independently be an end group or a side group (also referred to as a pendant group).

In certain embodiments, the vinyl oligomer is a bifunctional vinyl oligomer comprising two vinyl groups (e.g., two vinyl end groups). In some instances, the vinyl oligomer comprises more than two vinyl groups. In certain instances, the vinyl oligomer comprises at least 3 vinyl groups, at least 4 vinyl groups, at least 5 vinyl groups, at least 6 vinyl groups, at least 7 vinyl groups, at least 8 vinyl groups, at least 9 vinyl groups, or at least 10 vinyl groups. In some cases, the vinyl oligomer comprises a number of vinyl groups in a range from 2 to 3, 2 to 5, 2 to 10, 3 to 5, 3 to 10, or 5 to 10. In some cases, the vinyl oligomer comprises 2, 3, 4, 5, 6, 7, 8, 9, or 10 vinyl groups.

The vinyl oligomer of a thiol-ene polymeric composition may have any suitable backbone. Examples of suitable backbones for the vinyl oligomer include, but are not limited to, polydimethylsiloxane (PDMS), polyethylene glycol (PEG), poly(ethylene glycol-ethylene sulfide) (PEG-PES), polyurethane, and polyurethane diacrylates (PUA).

The backbone of the vinyl oligomer may have any suitable length. In some embodiments, the backbone comprises at least 1 repeat unit, at least 2 repeat units, at least 5 repeat units, at least 10 repeat units, at least 20 repeat units, at least 50 repeat units, at least 100 repeat units, at least 200 repeat units, or at least 500 repeat units. In some embodiments, the number of repeat units in the backbone of the vinyl oligomer is in a range from 1 to 5, 1 to 10, 1 to 20, 1 to 50, 1 to 100, 1 to 200, 1 to 500, 10 to 20, 10 to 50, 10 to 100, 10 to 200, 10 to 500, 50 to 100, 50 to 200, 50 to 500, 100 to 200, 100 to 500, or 200 to 500. The number of repeat units of the vinyl oligomer may be determined using gel permeation chromatography (GPC), nuclear magnetic resonance (NMR), or may be obtained from a manufacturer's specifications.

The vinyl oligomer of a thiol-ene polymeric composition may have any suitable number average molecular weight Mₙ. Number average molecular weight Mₙ may be obtained by taking the number average of the molecular weights of individual polymer molecules, according to the following formula:

$${M}_{n} = \frac{\sum {M}_{i} {N}_{i}}{\sum {N}_{i}} \qquad ( 1 )$$

where Nᵢ is the number of molecules of molecular weight Mᵢ. The number average molecular weight of a vinyl oligomer may be obtained using gel permeation chromatography (GPC).

In some embodiments, a vinyl oligomer having a relatively low number average molecular weight Mₙ may advantageously lead to a higher switching magnitude for a thiol-ene polymeric composition (e.g., a higher value of log₁₀ G′_{off}/G′ₒₙ, where G′_{off} is the storage modulus G′ when electromagnetic radiation is off and G′ₒₙ is the storage modulus G′ when electromagnetic radiation is on). In certain embodiments, a vinyl oligomer of a thiol-ene polymeric composition has a number average molecular weight Mₙ of 50 kDa or less, 40 kDa or less, 30 kDa or less, 28 kDa or less, 25 kDa or less, 20 kDa or less, 15 kDa or less, 14 kDa or less, 10 kDa or less, 9.4 kDa or less, 5 kDa or less, 2 kDa or less, 1 kDa or less, 0.8 kDa or less, or 0.5 kDa or less. However, if the number average molecular weight Mₙ of a vinyl oligomer is too low, a thiol-ene polymeric composition comprising the vinyl oligomer may be unable to cure upon exposure to electromagnetic radiation. In some embodiments, a vinyl oligomer of a thiol-ene polymeric composition has a number average molecular weight Mₙ of at least 0.5 kDa, at least 0.8 kDa, at least 1 kDa, at least 2 kDa, at least 5 kDa, at least 9.4 kDa, at least 10 kDa, at least 14 kDa, at least 15 kDa, at least 20 kDa, at least 25 kDa, at least 28 kDa, at least 30 kDa, at least 40 kDa, or at least 50 kDa. In some embodiments, a vinyl oligomer of a thiol-ene polymeric composition has a number average molecular weight Mₙ in a range from 0.5 kDa to 1 kDa, 0.5 kDa to 5 kDa, 0.5 kDa to 9.4 kDa, 0.5 kDa to 10 kDa, 0.5 kDa to 15 kDa, 0.5 kDa to 20 kDa, 0.5 kDa to 25 kDa, 0.5 kDa to 28 kDa, 0.5 kDa to 30 kDa, 0.5 kDa to 40 kDa, 0.5 kDa to 50 kDa, 0.8 kDa to 5 kDa, 0.8 kDa to 9.4 kDa, 0.8 kDa to 10 kDa, 0.8 kDa to 14 kDa, 0.8 kDa to 15 kDa, 0.8 kDa to 20 kDa, 0.8 kDa to 25 kDa, 0.8 kDa to 28 kDa, 0.8 kDa to 30 kDa, 0.8 kDa to 40 kDa, 0.8 kDa to 50 kDa, 5 kDa to 9.4 kDa, 5 kDa to 10 kDa, 5 kDa to 15 kDa, 5 kDa to 20 kDa, 5 kDa to 25 kDa, 5 kDa to 28 kDa, 5 kDa to 30 kDa, 5 kDa to 40 kDa, 5 kDa to 50 kDa, 9.4 kDa to 14 kDa, 9.4 kDa to 15 kDa, 9.4 kDa to 20 kDa, 9.4 kDa to 25 kDa, 9.4 kDa to 28 kDa, 9.4 kDa to 30 kDa, 9.4 kDa to 40 kDa, 9.4 kDa to 50 kDa, 14 kDa to 20 kDa, 14 kDa to 25 kDa, 14 kDa to 28 kDa, 14 kDa to 30 kDa, 14 kDa to 40 kDa, 14 kDa to 50 kDa, 15 kDa to 20 kDa, 15 kDa to 25 kDa, 15 kDa to 28 kDa, 15 kDa to 30 kDa, 15 kDa to 40 kDa, 15 kDa to 50 kDa, 20 kDa to 25 kDa, 20 kDa to 28 kDa, 20 kDa to 30 kDa, 20 kDa to 40 kDa, 20 kDa to 50 kDa, 28 kDa to 40 kDa, 28 kDa to 50 kDa, 30 kDa to 50 kDa, or 40 kDa to 50 kDa.

### Thiol Oligomer

In some embodiments, a thiol-ene polymeric composition comprises a first thiol oligomer comprising at least two thiol groups. As used herein, a “thiol group” refers to an “—SH group.” Each of the at least two thiol groups of the first thiol oligomer may independently be an end group or a side group.

In certain embodiments, the first thiol oligomer is a polyfunctional thiol oligomer comprising more than two thiol groups. In some cases, the first thiol oligomer comprises at least 3 thiol groups, at least 4 thiol groups, at least 5 thiol groups, at least 6 thiol groups, at least 7 thiol groups, at least 8 thiol groups, at least 9 thiol groups, at least 10 thiol groups, at least 15 thiol groups, or at least 20 thiol groups. In some cases, the first thiol oligomer comprises a number of thiol groups in a range from 2 to 3, 2 to 5, 2 to 10, 2 to 15, 2 to 20, 3 to 5, 3 to 10, 3 to 15, 3 to 20, 5 to 10, 5 to 15, 5 to 20, or 10 to 20. In some cases, the first thiol oligomer comprises 2, 3, 4, 5, 6, 7, 8, 9, 10, 15, or 20 thiol groups.

In some embodiments, a thiol-ene polymeric composition comprises a second thiol oligomer comprising at least two thiol groups. Each of the at least two thiol groups of the second thiol oligomer may independently be an end group or a side group.

In certain embodiments, the second thiol oligomer is a bifunctional thiol oligomer comprising two thiol groups (e.g., two thiol end groups). In some instances, the second thiol oligomer comprises more than two thiol groups. In certain instances, the second thiol oligomer comprises at least 3 thiol groups, at least 4 thiol groups, at least 5 thiol groups, at least 6 thiol groups, at least 7 thiol groups, at least 8 thiol groups, at least 9 thiol groups, at least 10 thiol groups, at least 15 thiol groups, or at least 20 thiol groups. In some cases, the second thiol oligomer comprises a number of thiol groups in a range from 2 to 3, 2 to 5, 2 to 10, 2 to 15, 2 to 20, 3 to 5, 3 to 10, 3 to 15, 3 to 20, 5 to 10, 5 to 15, 5 to 20, or 10 to 20. In some cases, the second thiol oligomer comprises 2, 3, 4, 5, 6, 7, 8, 9, 10, 15, or 20 thiol groups.

In some embodiments, the first thiol oligomer comprises a larger number of thiol groups than the second thiol oligomer. In some instances, for example, the first thiol oligomer comprises more than 2 thiol groups and the second thiol oligomer comprises 2 thiol groups. In certain cases, increasing the ratio of the second thiol oligomer to the first thiol oligomer in the thiol-ene polymeric composition may advantageously increase switching magnitude (e.g., log₁₀ G′_{off}/G′ₒₙ). However, increasing the ratio of the second thiol oligomer to the first thiol oligomer may also have the deleterious effect of reducing the storage modulus G′_{off} in the solid state of the thiol-ene composition. In some embodiments, a thiol-ene polymeric composition comprises a larger amount of the first thiol oligomer than the second thiol oligomer. In certain embodiments, a ratio of the first thiol oligomer to the second thiol oligomer in a thiol-ene polymeric composition is at least 3:1, at least 4:1, at least 5:1, at least 6:1, at least 7:1, at least 8:1, at least 9:1, at least 10:1, at least 15:1, or at least 20:1. In certain embodiments, a ratio of the first thiol oligomer to the second thiol oligomer in a thiol-ene polymeric composition is in a range from 3:1 to 5:1, 3:1 to 8:1, 3:1 to 10:1, 3:1 to 15:1, 3:1 to 20:1, 5:1 to 8:1, 5:1 to 10:1, 5:1 to 15:1, 5:1 to 20:1, 8:1 to 10:1, 8:1 to 15:1, 8:1 to 20:1, 10:1 to 15:1, 10:1 to 20:1, or 15:1 to 20:1. In certain instances, a ratio of the first thiol oligomer to the second thiol oligomer in a thiol-ene polymeric composition is 3:1, 4:1, 5:1, 6:1, 7:1, 8:1, 9:1, 10:1, 15:1, or 20:1. The ratio of the first thiol oligomer to the second thiol oligomer may be obtained based on the molar content of the first thiol oligomer and the second thiol oligomer. The molar content of the second thiol oligomer may be represented as X %, and the molar content of the first thiol oligomer may be represented as (100−X) %. The ratio of the first thiol oligomer to the second thiol oligomer may be (100−X):X.

The first thiol oligomer and/or second thiol oligomer may independently have any suitable backbone. Examples of suitable backbones include, but are not limited to, polydimethylsiloxane (PDMS), polyethylene glycol (PEG), poly(ethylene glycol-ethylene sulfide) (PEG-PES), polyurethane, and polyurethane diacrylates (PUA).

The backbone may have any suitable length. In certain embodiments, the backbone comprises at least 1 repeat unit, at least 2 repeat units, at least 5 repeat units, at least 8 repeat units, at least 10 repeat units, at least 15 repeat units, at least 20 repeat units, at least 50 repeat units, at least 80 repeat units, or at least 100 repeat units. In certain embodiments, the backbone comprises 100 repeat units or less, 80 repeat units or less, 50 repeat units or less, 20 repeat units or less, 15 repeat units or less, 10 repeat units or less, 8 repeat units or less, 5 repeat units or less, 2 repeat units or less, or 1 repeat unit or less. In certain embodiments, the number of repeat units in the backbone of the first thiol oligomer and/or the second thiol oligomer is in a range from 1 to 5, 1 to 10, 1 to 20, 1 to 50, 1 to 100, 5 to 10, 5 to 20, 5 to 50, 5 to 100, 10 to 20, 10 to 50, 10 to 100, 20 to 50, 20 to 100, or 50 to 100.

The first thiol oligomer and/or second thiol oligomer may independently have any suitable molecular weight. In some embodiments, the first thiol oligomer and/or second thiol oligomer have a number average molecular weight Mₙ of about 50 kDa or less, 40 kDa or less, 30 kDa or less, 25 kDa or less, 20 kDa or less, 15 kDa or less, 10 kDa or less, 7 kDa or less, 5 kDa or less, 2 kDa or less, 1 kDa or less, or 0.5 kDa or less. In some embodiments, the first thiol oligomer and/or second thiol oligomer of a thiol-ene polymeric composition have a number average molecular weight Mₙ in a range from 0.5 kDa to 1 kDa, 0.5 kDa to 5 kDa, 0.5 kDa to 7 kDa, 0.5 kDa to 10 kDa, 0.5 kDa to 15 kDa, 0.5 kDa to 20 kDa, 0.5 kDa to 25 kDa, 0.5 kDa to 30 kDa, 0.5 kDa to 40 kDa, 0.5 kDa to 50 kDa, 1 kDa to 5 kDa, 1 kDa to 7 kDa, 1 kDa to 10 kDa, 1 kDa to 15 kDa, 1 kDa to 20 kDa, 1 kDa to 25 kDa, 1 kDa to 30 kDa, 1 kDa to 40 kDa, 1 kDa to 50 kDa, 5 kDa to 7 kDa, 5 kDa to 10 kDa, 5 kDa to 15 kDa, 5 kDa to 20 kDa, 5 kDa to 25 kDa, 5 kDa to 30 kDa, 5 kDa to 40 kDa, 5 kDa to 50 kDa, 7 kDa to 15 kDa, 7 kDa to 20 kDa, 7 kDa to 25 kDa, 7 kDa to 30 kDa, 7 kDa to 40 kDa, 7 kDa to 50 kDa, 10 kDa to 20 kDa, 10 kDa to 25 kDa, 10 kDa to 30 kDa, 10 kDa to 40 kDa, 10 kDa to 50 kDa, 15 kDa to 20 kDa, 15 kDa to 25 kDa, 15 kDa to 30 kDa, 15 kDa to 40 kDa, 15 kDa to 50 kDa, 20 kDa to 25 kDa, 20 kDa to 30 kDa, 20 kDa to 40 kDa, 20 kDa to 50 kDa, 30 kDa to 50 kDa, or 40 kDa to 50 kDa.

In some embodiments, a thiol-ene polymeric composition has a ratio of a number average molecular weight of a vinyl oligomer to a number average molecular weight of a first thiol oligomer in a range of 1:10 to 1:2, 1:10 to 1:1, 1:10 to 2:1, 1:10 to 10:1, 1:2 to 1:1, 1:2 to 2:1, 1:2 to 10:1, 1:1 to 2:1, or 1:1 to 10:1. In certain embodiments, the number average molecular weight of the first thiol oligomer is relatively similar to the number average molecular weight of the vinyl oligomer.

In some embodiments, a thiol-ene polymeric composition has a ratio of thiol groups to vinyl groups that is greater than 1:1 (i.e., there are more thiol groups than vinyl groups in the composition). In certain cases, a higher ratio of thiol to vinyl groups may advantageously increase switching magnitude (e.g., log₁₀ G′_{off}/G′ₒₙ). In certain embodiments, the ratio of thiol groups to vinyl groups in the thiol-ene polymeric composition is at least 2:1, at least 3:1, at least 4:1, at least 5:1, at least 6:1, at least 7:1, at least 8:1, at least 9:1, at least 10:1, at least 15:1, or at least 20:1. In some instances, the ratio of thiol groups to vinyl groups in the thiol-ene polymeric composition is in a range from 2:1 to 3:1, 2:1 to 5:1, 2:1 to 10:1, 2:1 to 15:1, 2:1 to 20:1, 3:1 to 5:1, 3:1 to 10:1, 3:1 to 15:1, 3:1 to 20:1, 5:1 to 10:1, 5:1 to 15:1, 5:1 to 20:1, 10:1 to 15:1, 10:1 to 20:1, or 15:1 to 20:1.

The ratio of thiol groups to vinyl groups in a thiol-ene polymeric composition is a ratio of the overall thiol content of the composition to overall vinyl content of the composition. The overall thiol content may be obtained by, for each type of thiol oligomer, multiplying a molar fraction of the thiol oligomer in the composition by the number of thiol groups of the thiol oligomer, and calculating the sum of the resulting products. The overall vinyl content may be similarly obtained by, for each type of vinyl oligomer, multiplying a molar fraction of the vinyl oligomer present in the composition by the number of vinyl groups of the vinyl oligomer, and calculating the sum of the resulting products.

In some embodiments, a thiol-ene polymeric composition has a ratio of thiol groups to vinyl groups in a range from 3:1 to 10:1 or 3:1 to 20:1 when a number average molecular weight of the vinyl oligomer is in a range from 1 kDa to 25 kDa, 5 kDa to 30 kDa, or 9.4 kDa to 28 kDa. In some embodiments, a thiol-ene polymeric composition has a ratio of thiol groups to vinyl groups in a range from 3:1 to 10:1 or 3:1 to 20:1 when a ratio of a number average molecular weight of a vinyl oligomer to a number average molecular weight of a first thiol oligomer of the polymeric composition is in a range of 1:2 to 2:1 or 1:1 to 2:1. In certain embodiments, a thiol-ene polymeric composition has a ratio of thiol groups to vinyl groups in a range from 2:1 to 10:1 or 2:1 to 20:1 when a number average molecular weight of the vinyl oligomer is in a range from 0.5 kDa to 10 kDa, 0.5 kDa to 30 kDa, 0.8 kDa to 9.4 kDa, or 0.8 kDa to 28 kDa. In certain embodiments, a thiol-ene polymeric composition has a ratio of thiol groups to vinyl groups in a range from 2:1 to 10:1 or 2:1 to 20:1 when a ratio of a number average molecular weight of a vinyl oligomer to a number average molecular weight of a first thiol oligomer of the polymeric composition is in a range of 1:10 to 2:1 or 1:10 to 1:1.

### Photoinitiator

In some embodiments, a thiol-ene polymeric composition comprises a photoinitiator. The photoinitiator may be a Type I photoinitiator. In some cases, the presence of a Type I photoinitiator may advantageously lead to large switching magnitudes upon exposure to electromagnetic radiation. Non-limiting examples of suitable Type I photoinitiators include 2-hydroxy-2-methyl propiophenone (HMPP, Irgacure I1173), 1-hydroxycyclohexyl phenyl ketone (HCPK, Irgacure 184), 2-methyl-4′-(methylthio)-2-morpholinopropiophenone (MMMP), phenylbis(2,4,6-trimethylbenzoyl)phosphine oxide (BAPO), and 2,2-dimethoxy-2-phenylacetophenone (DMPA). In some cases, the use of HMPP advantageously results in large switching magnitude and stability over numerous switching cycles.

In some embodiments, the thiol-ene polymeric composition comprises a relatively high concentration of photoinitiator. In some cases, increasing photoinitiator concentration may increase the concentration of radicals in the system and thus the reaction rate. In some such cases, an increase in photoinitiator concentration may lead to an increase in switching magnitude (e.g., as represented by the change in storage modulus G′ in the off state versus on state). In some embodiments, the concentration of photoinitiator in the thiol-ene polymeric composition is at least 30 μmol/cm³, at least 60 μmol/cm³, at least 90 μmol/cm³, at least 100 mol/cm³, at least 120 μmol/cm³, or at least 240 μmol/cm³. In some embodiments, the concentration of the photoinitiator in the thiol-ene polymeric composition is in a range from 30 to 60 μmol/cm³, 30 to 90 μmol/cm³, 30 to 100 μmol/cm³, 30 to 120 μmol/cm³, 30 to 240 mol/cm³, 60 to 90 μmol/cm³, 60 to 100 μmol/cm³, 60 to 120 μmol/cm³, 60 to 240 μmol/cm³, 90 to 120 μmol/cm³, 90 to 240 μmol/cm³, or 120 to 240 μmol/cm³.

### Switching Properties

In some embodiments, switching between a solid state and a liquid state of the thiol-ene polymeric composition may be induced by exposure of at least a portion of the thiol-ene polymeric composition to an amount of electromagnetic radiation. In some embodiments, switching may be induced by a relatively small amount of electromagnetic radiation. In certain cases, for example, photo-induced switching of thiol-ene polymeric compositions may advantageously require less energy than thermally activated switching of vitrimers. As one non-limiting example, more than 90% stress relaxation may be achieved upon exposure of a thiol-ene polymeric composition to 36.5 mJ/cm² of electromagnetic radiation, while heating a PDMS vitrimer from 25° C. to 150° C. may require 8.32 J/cm².

In some embodiments, switching between a solid state and a liquid state of the thiol-ene polymeric composition may be induced by an amount of electromagnetic radiation of 1 J/cm² or less, 800 mJ/cm² or less, 500 mJ/cm² or less, 200 mJ/cm² or less, 150 mJ/cm² or less, 100 mJ/cm² or less, 75 mJ/cm² or less, 50 mJ/cm² or less, 36.5 mJ/cm² or less, 25 mJ/cm² or less, or 10 mJ/cm² or less. In some embodiments, switching between a solid state and a liquid state of the thiol-ene polymeric composition may be induced by an amount of electromagnetic radiation in a range from 10 to 36.5 mJ/cm², 10 to 50 mJ/cm², 10 to 75 mJ/cm², 10 to 100 mJ/cm², 10 to 200 mJ/cm², 10 to 500 mJ/cm², 10 to 800 mJ/cm², 10 mJ/cm² to 1 J/cm², 36.5 to 50 mJ/cm², 36.5 to 75 mJ/cm², 36.5 to 100 mJ/cm², 36.5 to 200 mJ/cm², 36.5 to 500 mJ/cm², 36.5 to 800 mJ/cm², 36.5 mJ/cm² to 1 J/cm², 50 to 100 mJ/cm², 50 to 200 mJ/cm², 50 to 500 mJ/cm², 50 to 800 mJ/cm², 50 mJ/cm² to 1 J/cm², 100 to 200 mJ/cm², 100 to 500 mJ/cm², 100 to 800 mJ/cm², 100 mJ/cm² to 1 J/cm², 200 to 500 mJ/cm², 200 to 800 mJ/cm², 200 mJ/cm² to 1 J/cm², or 500 mJ/cm² to 1 J/cm². The electromagnetic radiation may be provided by any source of electromagnetic radiation (e.g., a laser, a light-emitting diode (LED), a lamp).

In some cases, switching of a thiol-ene polymeric composition between a solid state and a liquid state may be induced by electromagnetic radiation having any suitable wavelength. In certain embodiments, the electromagnetic radiation comprises one or more wavelengths (e.g., one or more peak wavelengths) in a range from 100 nm to 200 nm, 100 nm to 280 nm, 100 nm to 300 nm, 100 nm to 400 nm, 100 nm to 700 nm, 100 nm to 1 μm, 230 nm to 330 nm, 245 nm to 331 nm, 250 nm to 600 nm, 275 nm to 377 nm, 280 nm to 315 nm, 290 nm to 400 nm, 315 nm to 400 nm, 400 nm to 500 nm, 400 nm to 600 nm, 400 nm to 700 nm, or 400 nm to 1 μm. In certain embodiments, the electromagnetic radiation comprises one or more wavelengths (e.g., one or more peak wavelengths) in an ultraviolet region of the spectrum. In certain embodiments, the electromagnetic radiation comprises broadband radiation.

Switching of a thiol-ene polymeric composition between a solid state and a liquid state may occur across a wide range of temperatures. In some cases, switching of the thiol-ene polymeric composition occurs at a temperature of at least 20° C., at least 25° C., at least 30° C., at least 37° C., at least 40° C., at least 50° C., at least 60° C., at least 70° C., at least 80° C., at least 90° C., or at least 100° C. In some cases, switching of the thiol-ene polymer occurs at a temperature of 100° C. or less, 90° C. or less, 80° C. or less, 70° C. or less, 60° C. or less, 50° C. or less, 40° C. or less, 37° C. or less, 30° C. or less, 25° C. or less, or 20° C. or less. In some cases, switching of the thiol-ene polymeric composition occurs at a temperature in a range from 20° C. to 25° C., 20° C. to 30° C., 20° C. to 37° C., 20° C. to 40° C., 20° C. to 50° C., 20° C. to 60° C., 20° C. to 70° C., 20° C. to 80° C., 20° C. to 90° C., 20° C. to 100° C., 25° C. to 30° C., 25° C. to 37° C., 25° C. to 40° C., 25° C. to 50° C., 25° C. to 60° C., 25° C. to 70° C., 25° C. to 80° C., 25° C. to 90° C., 25° C. to 100° C., 37° C. to 50° C., 37° C. to 60° C., 37° C. to 70° C., 37° C. to 80° C., 37° C. to 90° C., 37° C. to 100° C., 50° C. to 60° C., 50° C. to 70° C., 50° C. to 80° C., 50° C. to 90° C., 50° C. to 100° C., 60° C. to 80° C., 60° C. to 90° C., 60° C. to 100° C., 70° C. to 100° C., or 80° C. to 100° C. In some embodiments, switching of the thiol-ene polymeric composition occurs at about room temperature. In certain instances, switching of the thiol-ene polymeric composition occurs at a temperature in a range from 20° C. to 25° C.

In some embodiments, at least a portion (or, in some embodiments, substantially all) of a thiol-ene polymeric composition is in a liquid state during exposure to an amount of electromagnetic radiation (e.g., ultraviolet radiation). A composition in a liquid state generally refers to any composition that is capable of flowing. The thiol-ene polymeric composition in a liquid state may be in the form of a viscous liquid, a semi-solid, or any other flowable composition. In some embodiments, at least 10%, at least 20%, at least 50%, at least 80%, at least 90%, at least 95%, at least 99%, or approximately 100% of the volume of the composition is in a liquid state during exposure to an amount of electromagnetic radiation (e.g., ultraviolet radiation). In certain embodiments, the percent volume of the composition in a liquid state during exposure to an amount of electromagnetic radiation (e.g., ultraviolet radiation) is in a range from 10-20%, 10-50%, 10-80%, 10-90%, 10-95%, 10-99%, 10-100%, 50-80%, 50-90%, 50-95%, 50-99%, 50-100%, 80-95%, 80-99%, 80-100%, 90-100%, or 95-100%.

In some embodiments, a thiol-ene polymeric composition in a liquid state may have a relatively low viscosity. In certain embodiments, a thiol-ene polymeric composition in a liquid state has a viscosity of 10,000 Pa·s or less, 9000 Pa·s or less, 8000 Pa·s or less, 7000 Pa·s or less, 6000 Pa·s or less, 5000 Pa·s or less, 4000 Pa·s or less, 3000 Pa·s or less, 2000 Pa·s or less, or 1000 Pa·s or less. In certain embodiments, a thiol-ene polymeric composition in a liquid state has a viscosity in a range from 1000 to 2000 Pa·s, 1000 to 5000 Pa·s, 1000 to 10,000 Pa·s, 2000 to 5000 Pa·s, 2000 to 10,000 Pa·s, or 5000 to 10,000 Pa·s. Viscosity of the composition may be measured using a rheometer or a photo-rheometer.

In some embodiments, at least a portion (or, in some embodiments, substantially all) of a thiol-ene polymeric composition is in a solid state when not exposed to the amount of electromagnetic radiation (e.g., ultraviolet radiation). A composition in a solid state (e.g., an elastomeric state) generally refers to any composition that is not capable of flowing.

In some cases, a thiol-ene polymeric composition in a solid state exhibits thermal stability. In some embodiments, a storage modulus G′ may remain relatively constant (e.g., less than 10% change) across a range of temperatures from 20° C. to 100° C. In some applications where thermal cycling of devices is necessary (e.g., thermally activated actuators), temperature stability may be particularly advantageous.

In some embodiments, a thiol-ene polymeric composition in a solid state exhibits robust mechanical properties. For example, it may exhibit minimal hysteresis, minimal plastic deformation, minimal stress relaxation, and/or minimal creep. Without wishing to be bound by a particular theory, this may be attributed to the stability of covalent bonds in the absence of electromagnetic radiation.

In some embodiments, reversible switching between a solid state and a liquid state may be repeatable for a large number of cycles. In some cases, reversible switching may be repeated at least 1 time, at least 5 times, at least 10 times, at least 20 times, at least 50 times, at least 100 times, at least 150 times, at least 180 times, or at least 200 times. In some embodiments, the number of switching cycles is in a range from 1 to 10, 1 to 20, 1 to 50, 1 to 100, 1 to 150, 1 to 180, 1 to 200, 10 to 20, 10 to 50, 10 to 100, 10 to 150, 10 to 180, 10 to 200, 20 to 50, 20 to 100, 20 to 150, 20 to 180, 20 to 200, 50 to 100, 50 to 150, 50 to 180, 50 to 200, 100 to 150, 100 to 180, 100 to 200, 150 to 180, 150 to 200, or 180 to 200.

In some embodiments, a switching magnitude (e.g., a change in magnitude of a mechanical property before and after exposure to electromagnetic radiation) may be relatively large. In some embodiments, the magnitude of log₁₀ G′_{off}/G′ₒₙ (where G′_{off} represents storage modulus G′ in the solid state and G′ₒₙ represents storage modulus G′ in the liquid state) is at least 0.1, 0.2, 0.3, 0.4, 0.5, 0.6, 0.7, 0.8, 0.9, 1.0, 1.2, or 1.5. In some embodiments, the magnitude of log₁₀ G′_{off}/G′ₒₙ is in a range from 0.1 to 0.3, 0.1 to 0.5, 0.1 to 0.8, 0.1 to 1.0, 0.1 to 1.2, 0.1 to 1.5, 0.3 to 0.5, 0.3 to 0.8, 0.3 to 1.0, 0.3 to 1.2, 0.3 to 1.5, 0.5 to 0.8, 0.5 to 1.0, 0.5 to 1.2, 0.5 to 1.5, 0.8 to 1.0, 0.8 to 1.2, 0.8 to 1.5, or 1.0 to 1.5.

In some embodiments, normalized stress may be significantly lower in a liquid state than a solid state of a thiol-ene polymeric composition. In some embodiments, normalized stress in the liquid state of the thiol-ene polymeric composition may be at least 40% lower, at least 50% lower, at least 60% lower, at least 70% lower, at least 80% lower, at least 90% lower, or at least 95% lower than normalized stress in the solid state of the thiol-ene polymeric composition. In certain embodiments, a percentage decrease in normalized stress from the solid state to the liquid state of a thiol-ene polymeric composition may be in the range of 40% to 60%, 40% to 80%, 40% to 90%, 40% to 95%, 50% to 80%, 50% to 90%, 50% to 95%, 60% to 80%, 60% to 90%, 60% to 95%, 80% to 90%, 80% to 95%, or 90% to 95%. In some cases, normalized stress may be measured by applying 20% strain in a photo-rheometer and subsequently measuring stress with and without exposure to electromagnetic radiation.

### Fabrication & Switching Methods

Some aspects are directed to methods of forming a thiol-ene polymeric composition. In some embodiments, a method of forming a thiol-ene polymeric composition comprises mixing a vinyl oligomer, a first thiol oligomer, and a Type I photoinitiator. In some embodiments, the method further comprises exposing the mixture to an amount of electromagnetic radiation for a period of time for curing.

Some aspects are directed to methods of switching from a solid state to a liquid state of a thiol-ene polymeric composition. In some embodiments, the method comprises exposing at least a portion of a thiol-ene polymeric composition to an amount of electromagnetic radiation over a first period of time. The thiol-ene polymeric composition may be any composition described herein and may comprise a vinyl oligomer comprising at least two vinyl groups, a first thiol oligomer comprising at least two thiol groups, and a Type I photoinitiator. In some embodiments, the step of exposing the composition to the amount of electromagnetic radiation comprises turning on a source of electromagnetic radiation, moving the source of electromagnetic radiation and/or the composition to expose at least a portion of the composition to electromagnetic radiation emitted by the source of electromagnetic radiation, removing shielding between the composition and the source of electromagnetic radiation, and/or otherwise exposing the composition to electromagnetic radiation.

In some embodiments, the composition is in a liquid state during at least a portion of the first period of time. In some embodiments, the first period of time is 60 seconds or less, 45 seconds or less, 30 seconds or less, 15 seconds or less, 10 seconds or less, or 5 seconds or less. In some embodiments, the first period of time is in a range from 5 seconds to 10 seconds, 5 seconds to 30 seconds, 5 seconds to 60 seconds, 5 seconds to 90 seconds, 10 seconds to 30 seconds, 10 seconds to 60 seconds, 10 seconds to 90 seconds, 30 seconds to 60 seconds, 30 seconds to 90 seconds, or 60 seconds to 90 seconds.

In some embodiments, the method further comprises not exposing the composition to the amount of electromagnetic radiation over a second period of time. In some cases, the step of not exposing the composition to the amount of electromagnetic radiation comprises turning off the source of electromagnetic radiation, moving the source of electromagnetic radiation and/or the composition to avoid exposing the composition to the electromagnetic radiation, placing shielding between the composition and the source of electromagnetic radiation, and/or otherwise shielding the composition from electromagnetic radiation.

In some embodiments, the composition is in a solid state during at least a portion of the second period of time. In some embodiments, the second period of time is 60 seconds or less, 45 seconds or less, 30 seconds or less, 15 seconds or less, 10 seconds or less, or 5 seconds or less. In some embodiments, the second period of time is in a range from 5 seconds to 10 seconds, 5 seconds to 30 seconds, 5 seconds to 60 seconds, 5 seconds to 90 seconds, 10 seconds to 30 seconds, 10 seconds to 60 seconds, 10 seconds to 90 seconds, 30 seconds to 60 seconds, 30 seconds to 90 seconds, or 60 seconds to 90 seconds.

In some embodiments, the method comprises adding an additional amount of the photoinitiator to a thiol-ene polymeric composition that has undergone at least one switching cycle. In some cases, adding additional photoinitiator may advantageously increase subsequent switching magnitude (e.g., by replenishing radicals). In some embodiments, the additional amount of photoinitiator is added after 5 cycles, 10 cycles, 15 cycles, 20 cycles, 25 cycles, 30 cycles, 40 cycles, 50 cycles, 60 cycles, 70 cycles, 80 cycles, 90 cycles, or 100 cycles. The additional amount of photoinitiator may be any suitable amount (the same, larger, or smaller than the initial amount of photoinitiator).

### Example 1

In this Example, several crosslinked polymer networks were prepared using compositions comprising bifunctional vinyl oligomers and multifunctional thiol oligomers with Norrish Type I photoinitiators (FIG. 1). Each of these compositions began as a liquid. When exposed to UV illumination during an initial curing step, radicals generated from the photoinitiators catalyzed the reaction of thiol and ene groups to form sulfide bonds, and the composition formed a solid elastomer when the UV illumination was turned off. When the UV illumination was turned on again, the elastomer changed back to the solution (sol) state and behaved like a viscous liquid. When the UV illumination was subsequently turned off, the composition again formed a solid elastomer and stopped flowing.

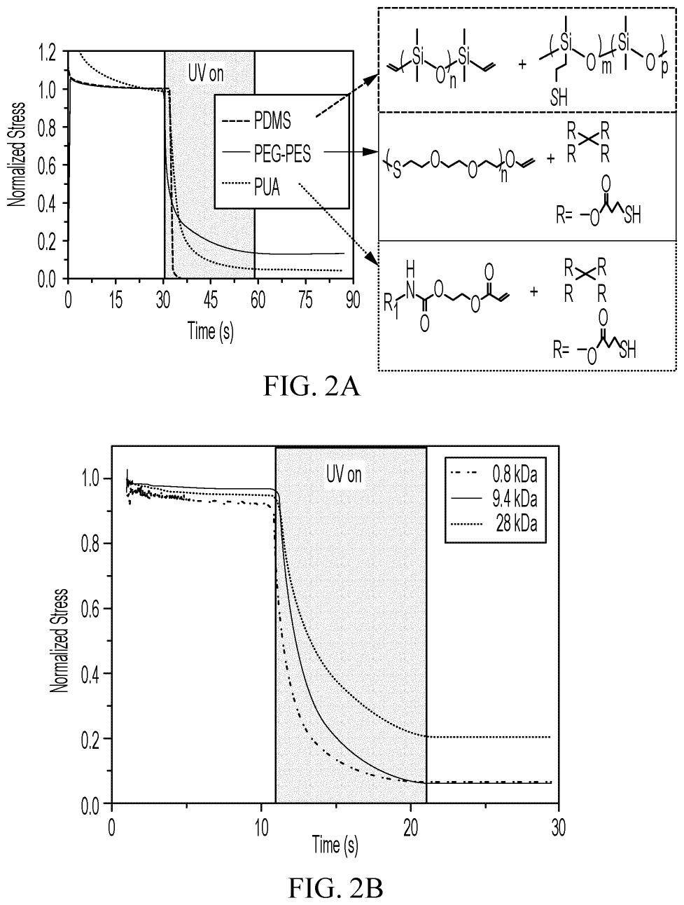

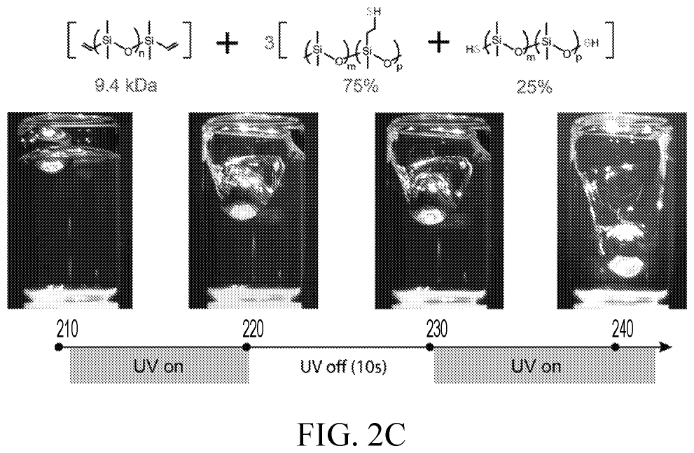

The generality of UV-induced dynamic bonding in thiol-ene networks was demonstrated using stress relaxation measurements on elastomer compositions with a wide diversity of backbone chemistries and vinyl groups. For example, FIG. 2A shows a plot of normalized stress over time for compositions comprising vinyl oligomers with backbones of polydimethylsiloxone (PDMS), poly(ethylene glycol-ethylene sulfide) (PEG-PES), and polyurethane diacrylates (PUA), with vinyl groups of allyl, vinyl ether, and acrylate, respectively. Each of the compositions further comprised a high content of polythiols and Type I photoinitiator Irgacure 11173 (2-hydroxy-2-methyl propiophenone, HMPP). During an initial 30-second period (about 0 to 30 seconds), the compositions were not exposed to UV illumination (no shading). During a second 30-second period (about 30 to 60 seconds), a UV source was turned on, and the compositions were exposed to UV illumination having an intensity of 16.7 mW/cm² (shading). During a third 30-second period (about 60 to 90 seconds), the UV source was turned off, and the compositions were again not exposed to UV illumination (no shading). As shown in FIG. 2A, in all compositions, nearly complete stress relaxation occurred during the 30 seconds of UV illumination.

Tests were also conducted with compositions comprising PDMS divinyl oligomers having molecular weights of 0.8, 9.4, and 28 kDa. During an initial time period (about 0 to 10 seconds), the compositions were not exposed to UV illumination (no shading). During a second time period (about 10 to 20 seconds), a UV source was turned on, and the compositions were exposed to UV illumination having an intensity of 3.65 mW/cm² (shading). During a third time period (about 20 to 30 seconds), the UV source was turned off, and the compositions were again not exposed to UV illumination (no shading). As shown in FIG. 2B, during the 10 seconds of low-intensity UV exposure (3.65 mW/cm²), compositions comprising the 0.8 kDa and 9.4 kDa PDMS divinyl oligomers showed approximately 90% stress relaxation, while a composition comprising the 28 kDa vinyl oligomer relaxed by approximately 80%. This 10-second UV exposure corresponded to an exposure dose of 36.5 mJ/cm². In comparison, assuming a heat capacity of 1.38 kJ/kg·K, heating a PDMS vitrimer from 25° C. to 150° C. requires 8.32 J/cm². This indicates that photodynamic thiol-ene polymers possess low energy requirements for polymer molding and reprocessing, potentially making them suitable for low-energy manufacturing applications. FIG. 2C illustrates the effect of UV illumination on the viscosity of a photodynamic thiol-ene elastomer with a 9.4 kDa divinyl PDMS backbone at 1:3 vinyl to thiol ratio, with 25% of dithiol DMS and 75% of polythiol DMS as crosslinking agents. In a variant of the classic Stokes experiment, a steel ball (8.2 g) was encased in the cured elastomer inside a glass vial. When the UV was off and the glass vial was turned upside down, the elastomer supported the steel ball (FIG. 2C, 1^{st} image 210). When illuminated through the glass with full UV intensity for 10 seconds, the steel ball began to move downwards under the influence of gravity, indicating a sharp drop in elastomer viscosity (FIG. 2C, 2^{nd} image 220). When UV was turned off for 10 seconds, the steel ball was frozen in place, indicating that the elastomer had returned to its original solid state (FIG. 2C, 3^{rd} image 230). This was repeated many times as UV was turned on and off (FIG. 2C, 4^{th} image 240). Particularly significant was that when additional photoinitiator was added to the cured elastomer, it rapidly diffused in and allowed the steel ball to fall faster when illuminated.

The effects of precursor composition and concentrations were explored using photo-rheology measurements. PDMS was used due to the availability of commercial oligomers with a wide range of molecular weights and functionalities. To understand the effect of material composition on the switching process, the ratio of thiol to vinyl moieties, the functionality of the thiol component, and the molecular weight of the divinyl component were systematically varied.

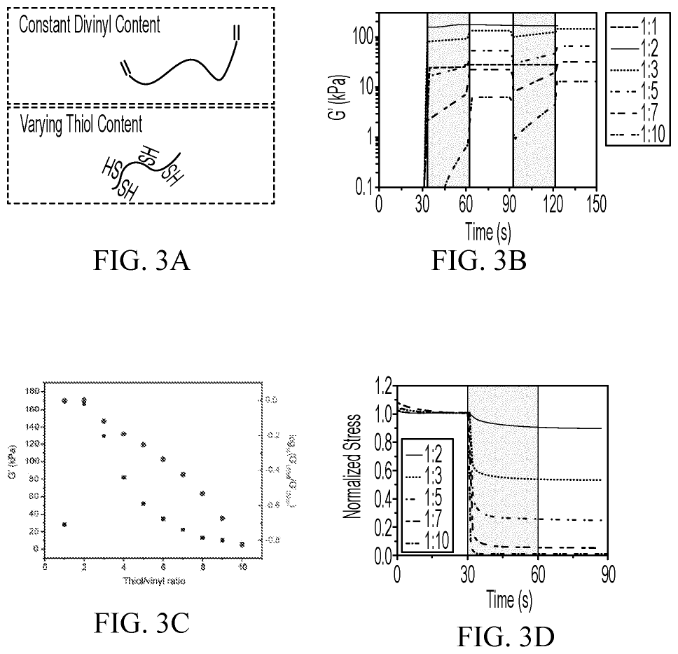

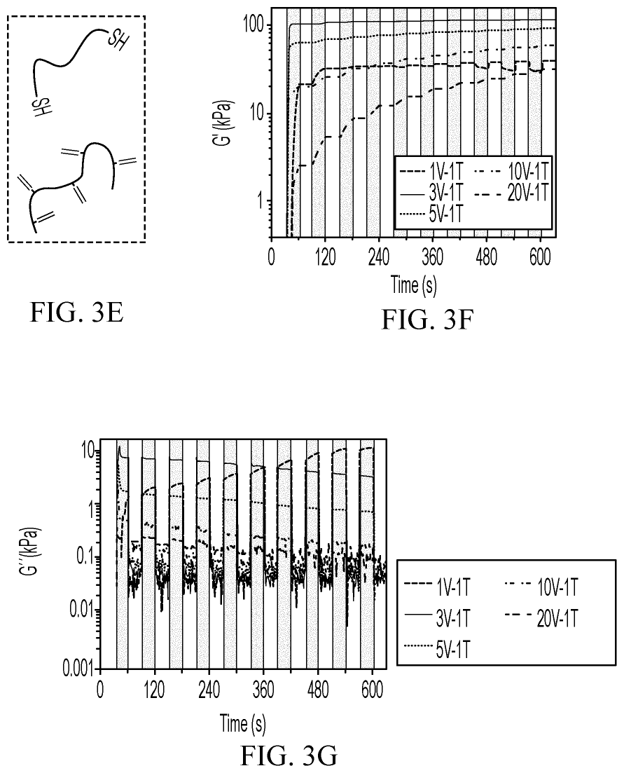

The effect of vinyl:thiol ratio was investigated using a divinyl oligomer with a molecular weight of 9.4 kDa (FIG. 3A). By adding different amounts of a thiol-functionalized oligomer with a functionality of about 4.75 and a molecular weight of 7 kDa (i.e., polythiol oligomer), the vinyl:thiol ratio was varied from 1:1 to 1:10. Samples were exposed to UV light (100 mW/cm²) for 30 seconds at a time with a period of 60 seconds. As shown in FIG. 3B, which shows storage modulus G′ (kPa) as a function of time (s) for compositions having vinyl:thiol ratios of 1:1, 1:2, 1:3, 1:5, 1:7, and 1:10, compositions with a vinyl:thiol ratio of 1:1 or 1:2 (near ideal stoichiometry) exhibited no photoswitching behavior in storage modulus G′. As shown in FIG. 3C, which shows storage modulus G′ (kPa) when UV was off and change in storage modulus G′ when UV was turned on (log₁₀ G′_{UVoff}/G′_{UVon}) as a function of thiol:vinyl ratio, for compositions with vinyl:thiol ratios greater than 1:3 (e.g., 1:4 to 1:10), the relative change in G′ (circles) increased with increasing thiol content, while the G′ in the solid state (UV off, squares) decreased with increasing thiol content. FIG. 3D, which shows normalized stress as a function of time, demonstrates that high thiol content compositions showed greater stress relaxation during the first 30 seconds of UV exposure. A control experiment was undertaken using a dithiol backbone and polyvinyl crosslinkers to test the effect of having excess vinyl groups (FIG. 3E). As shown in FIGS. 3F and 3G, which show storage modulus G′ (kPa, FIG. 3F) and loss modulus G″ (kPa, FIG. 3G) for compositions having excess vinyl groups, as the vinyl:thiol ratio was changed from 1:1 to 20:1, switching magnitudes decreased with increasing vinyl content. This observation that photodynamic behavior was promoted by excess thiol groups but not excess vinyl groups highlights the importance of free thiol groups to the photoswitching reaction.

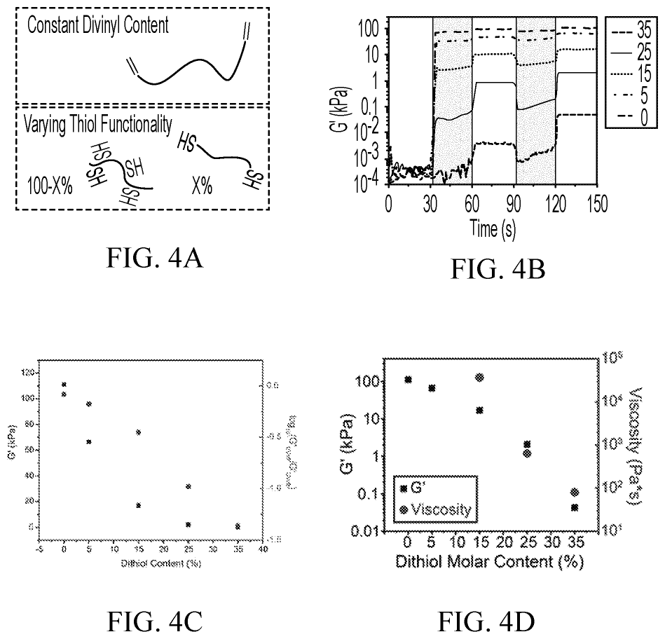

The effect of the functionality of the thiol component was investigated using the same divinyl oligomer with a molecular weight of 9.4 kDa (FIG. 4A). To isolate the effect of thiol functionality, the vinyl:thiol ratio was kept constant at 1:3 and the molar content of dithiols relative to polythiols was varied. FIG. 4B shows storage modulus G′ (kPa) as a function of time (s), and FIG. 4C shows storage modulus G′ when UV was off (squares) and relative change in G′ when UV was turned on (log₁₀ G′_{UVoff}/G′_{UVon}, circles). As shown in FIGS. 4B-4C, as the dithiol content (%) increased from 0% to 35%, the relative change in G′ increased, while the G′ in the solid state decreased. This was further illustrated by FIG. 4D, which shows G′ (UV off) and viscosity (Pa·s, UV on) as a function of dithiol molar content (%). Without wishing to be bound by a particular theory, this reduction in G′ with increasing dithiol content is consistent with the role of dithiols as chain extenders rather than crosslinkers in thiol-ene polymers. This strong dependence of the photoswitching behavior on the thiol functionality suggests a strong role of the polymer network structure on the flow behavior. According to the mathematical formulations of Flory and Stockmayer, the gel point generally shifts to larger bond conversion numbers as the functionality of precursors decreases, resulting in larger changes in the modulus upon UV exposure. Flory, The Journal of Physical Chemistry, 46:132 (1942). Interestingly, overlapping trends in the relative change in storage modulus G′ from the vinyl:thiol ratio experiment and the thiol functionality experiment were observed, suggesting that photoswitching behavior may be closely related to the network structure of the elastomer and the density of crosslinks.

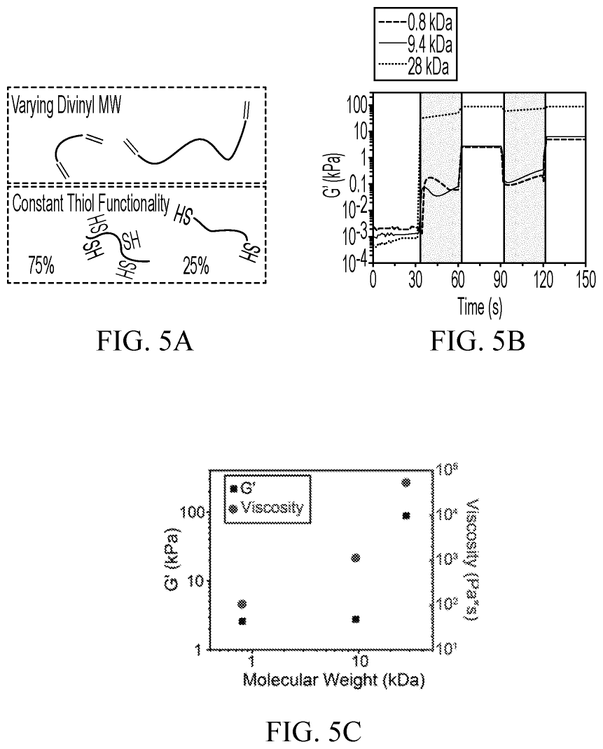

The effect of molecular weight of the divinyl component was investigated using oligomers with molecular weights of 0.8, 9.4, and 28 kDa (FIG. 5A). A 75:25 ratio of polythiol:dithiol at 25% dithiol content was adopted based on the favorable photoswitching behavior shown in FIG. 4B. At a vinyl:thiol ratio of 1:3, samples prepared with 9.4 kDa and 28 kDa divinyl oligomers exhibited large switching behavior, while the samples prepared with 0.8 kDa divinyl oligomers did not cure. Samples with divinyl oligomers having a molecular weight of 0.8 kDa were then prepared with a vinyl:thiol ratio of 1:2. Samples were initially cured for 60 seconds at 100 mW/cm². As shown in FIG. 5B, which shows storage modulus G′ (kPa) as a function of time (s), during subsequent UV on and off exposure, compositions comprising 0.8 kDa and 9.4 kDa vinyl oligomers exhibited higher G′ photoswitching than compositions comprising a 28 kDa vinyl oligomer. Continuous flow measurements were conducted by applying a constant shear stress and measuring the viscosity during UV exposure. As shown in FIG. 5C, storage modulus G′ (kPa) and viscosity (Pa·s) increased with increasing molecular weight (kDa) of the divinyl component. This ability to tune the viscosity of the sol state during UV exposure could inform the development of applications in which specific viscosities are required. G′ increased with the molecular weight of the vinyl component, while the photo-induced change in G′ decreased with the molecular weight.

Based on the results from FIGS. 2A-C, 3A-3G, 4A-4D, and 5A-5C, it was recognized that a thiol-ene polymeric composition with 9.4 kDa divinyl oligomers, a vinyl:thiol ratio of 1:3, and a polythiol:dithiol ratio of 75:25 had advantageous properties.

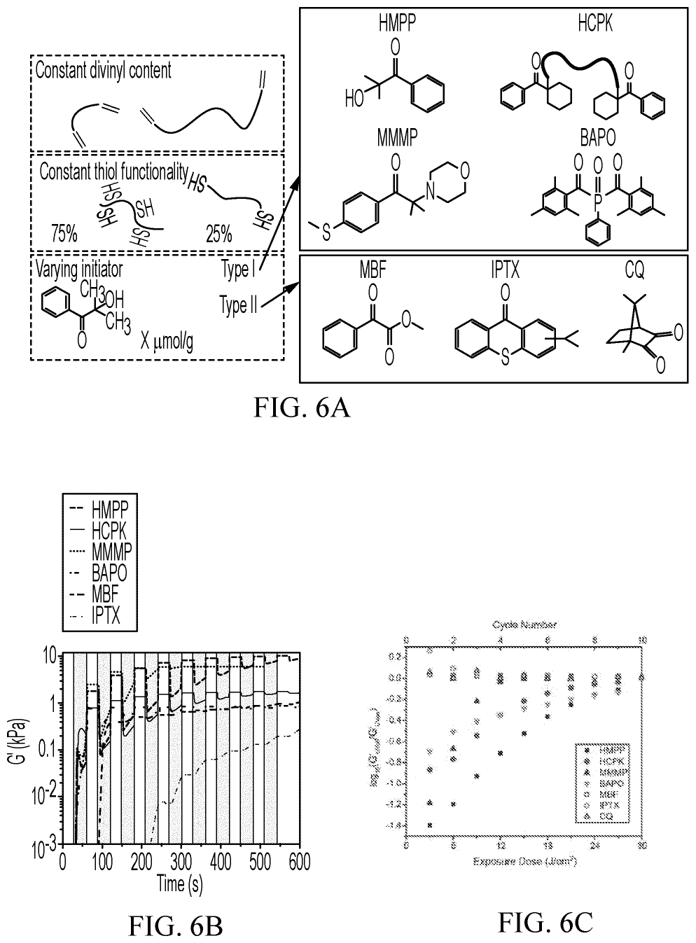

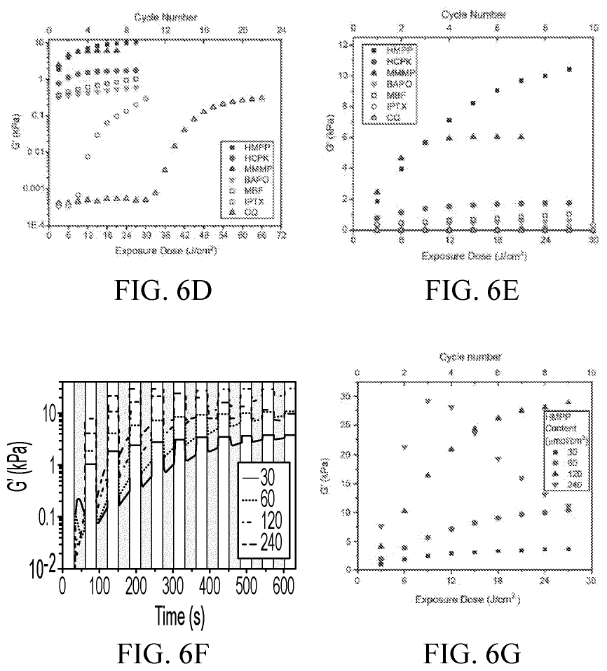

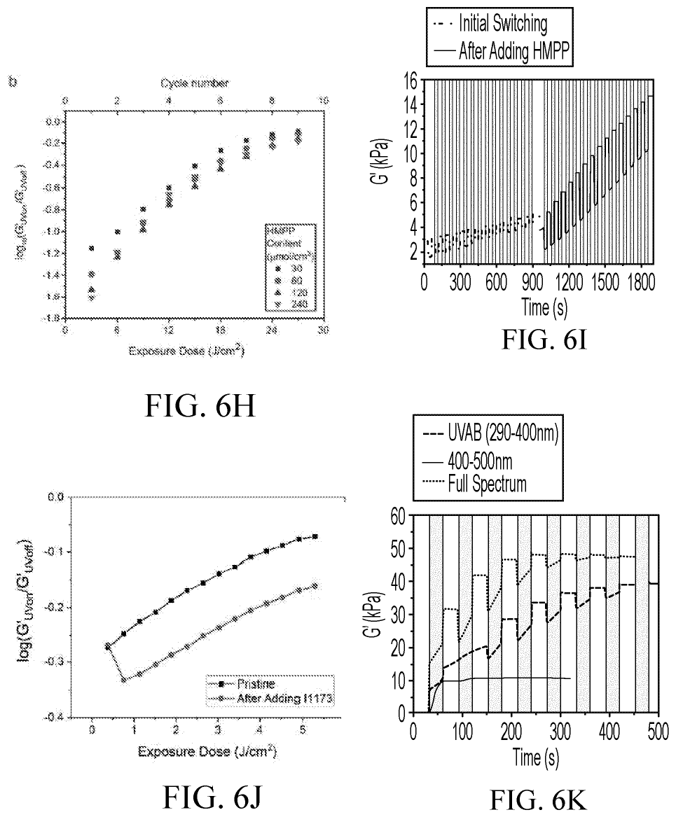

Keeping the 9.4 kDa divinyl component, the vinyl:thiol ratio of 1:3, and the polythiol:dithiol ratio of 3:1 constant, the stability and longevity of induced photoswitching were evaluated by varying radical concentration and UV intensity (i.e., variations that can lead to changes in the kinetics of radical initiation and recombination). The type and concentration of photoinitiators (FIG. 6A) were systematically varied. Type I radical initiators break into two fragments that each have one radical. In contrast, Type II initiators interact with a sensitizer that can donate an electron or hydrogen atom to generate a radical on the sensitizer. Common sensitizers include nitrogen or thiol groups. Experiments were conducted with four Type I photoinitiators: 2-hydroxy-2-methyl propiophenone (HMPP, Irgacure 1173), PDMS-functionalized 1-hydroxycyclohexyl phenyl ketone (HCPK, Irgacure 184), 2-methyl-4′-(methylthio)-2-morpholinopropiophenone (MMMP), and phenylbis(2,4,6-trimethylbenzoyl)phosphine oxide (BAPO). Experiments were also conducted with three Type II photoinitiators: methylbenzoylformate (MBF), isopropyl thioxanthone (IPTX), and camphorquinone (CQ). As shown in FIG. 6B, which shows storage modulus G′ over time for compositions comprising HMPP, HCPK, MMMP, BAPO, MBF, or IPTX, Type I initiators all showed large switching magnitudes. Of the Type I initiators tested, HMPP advantageously exhibited a combination of large switching magnitude and stability over many switching cycles. In contrast, the Type II initiators induced curing but did not exhibit switching, suggesting that the photoswitching mechanism relies on the presence of carbon-centered radicals that are provided by Type I but not Type II initiators. This is further confirmed by FIGS. 6C-E. FIG. 6C, which shows change in storage modulus G′ when UV is turned on over 9 cycles at an exposure of 100 mW/cm² for 30 seconds, shows that Type II initiators MBF, IPTX, and CQ exhibited virtually no change in storage modulus G′, while Type I initiators HMPP, HCPK, MMMP, and BAPO all exhibited significant switching effects. FIGS. 6D and 6E show storage modulus G′ as a function of cycle number and exposure dose (J/cm²) but on different vertical scales to emphasize the difference between the Type I and Type II initiators.

While the type of photoinitiator determines the types of radicals formed and how they react with other molecules, the amount of the photoinitiator determines the concentration of radicals in the system and the rate of reactions. As shown in FIG. 6F, which shows storage modulus G′ over time for compositions comprising 30, 60, 120, or 240 μmol/cm³ of HMPP, there was an increase in switching magnitude with increasing initiator concentration. FIGS. 6G and 6H show G′ (FIG. 6G) and change in log of the ratio of G′ in the on and off state (FIG. 6H) over 10 cycles of exposure to UV with 30, 60, 120, or 240 μmol/cm³ of HMPP.

It was also found that adding more HMPP photoinitiator to a sample that had already been cycled increased the magnitude of subsequent switching. In one set of experiments, additional initiator was added after 15 cycles of UV switching at 16.7 mW/cm². As shown in FIG. 6I, which shows storage modulus G′ over time, during the first 15 cycles, the magnitude of switching decreased with cycling, but increased when additional amounts of the initiator were added. Similarly, FIG. 6J shows UV-induced change in G′ for 15 cycles with 60 μmol/cm³ of HMPP and demonstrates that the change in G′ increased after adding another 60 mol/cm³ of HMPP. This indicates that photoswitching behavior may be dependent on the creation of radicalized species and that the radicalized species can be replenished.

Results also indicate that lower switching magnitudes were exhibited when illuminated in the UVAB (290-400 nm) portion of the spectrum. Indeed, as shown in FIG. 6K, almost no switching effects were observed when only illuminated in the 400-500 nm range. This may be attributed to the fact that HMPP absorbs between 245-331 nm and not at the longer wavelengths.

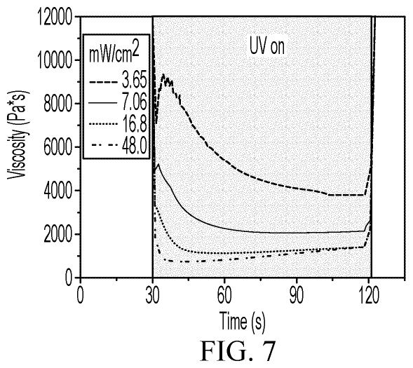

Tests were conducted at different UV intensities. FIG. 7 shows viscosity measurements at UV intensities of 3.65, 7.06, 16.8, and 48.0 mW/cm². The composition comprised a divinyl component with a molecular weight of 9.4 kDa, a thiol:vinyl ratio of 3:1, and a ratio of polythiols to dithiol of 3:1. The viscosity plotted in FIG. 5C was taken as the minimum stable value of the viscosity during UV exposure. For the low UV intensity of 3.65 mW/cm², this occurred at about 110 seconds, while for the highest UV intensity of 48 mW/cm², this occurred at about 40 seconds. For the high UV intensity of 48 mW/cm², the viscosity increased after the minimum due to UV-induced depletion of the initiator. The viscosity when the UV was off (less than 30 seconds and greater than 120 seconds) was not measurable due to the solid-like nature of the material.

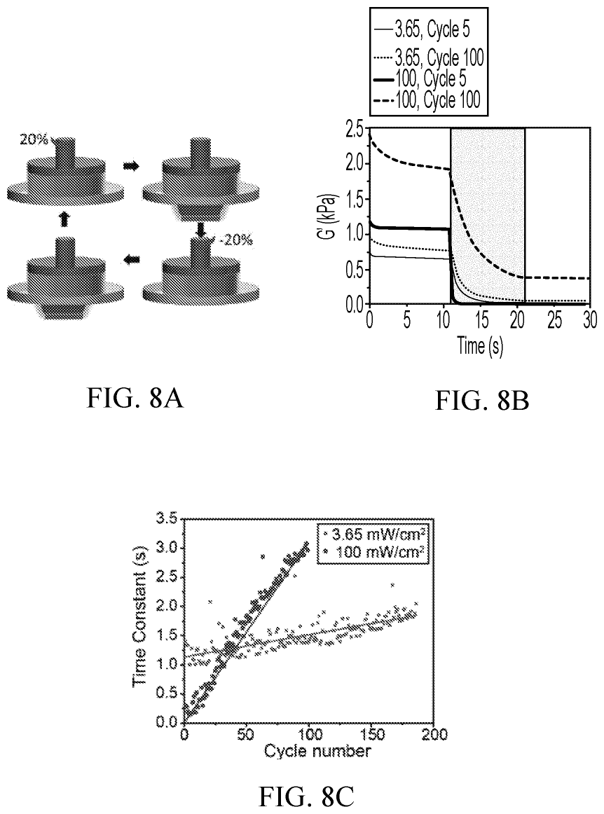

Creep-recovery and stress-relaxation behavior of the thiol-ene polymer were examined in situ to demonstrate elastomeric performance and the time constants associated with full relaxation behavior and reversible switching stability under different UV intensities and prolonged cycling. A schematic of the cycle testing, which consisted of a series of stress relaxation measurements at 20% shear strain with a UV exposure time of 10 seconds, is shown in FIG. 8A. Using a low UV intensity of 3.65 mW/cm², the stress relaxation measurements at cycle 5 (solid curves) and cycle 100 (dotted curves) were similar, while cycling measurements conducted at 100 mW/cm² showed an increase in the baseline modulus, consistent with the progressive curing with UV exposure, and incomplete stress relaxation within the 10 second UV exposure time (FIG. 8B). At low intensity, the elastomer exhibited relatively good reversible dynamic switching with increasing number of cycles. However, at full UV intensity, the elastomer exhibited fast recovery in the first several cycles, but the time constant for stress relaxation increased linearly with cycle number at a higher rate than with samples exposed to 20% intensity. As shown in FIG. 8C, at a UV intensity of 3.65 mW/cm², the time constants extracted from the stress relaxation measurements increased from approximately 1.2 seconds to 1.8 seconds over 180 cycles. At an intensity of 100 mW/cm², the time constant was less than 0.2 seconds at low cycle numbers but increased with cycle number to a value greater than 3 seconds at 100 cycles. Without wishing to be bound by a particular theory, the faster stress relaxation at higher UV intensity may be due to the larger proportion of dynamic bonds induced by the higher concentration of photoinduced radicals. However, the higher UV intensity may also deplete the photoinitiator more quickly, limiting the cycle life of the switching behavior. By the 50th cycle, the elastomer no longer reached full stress relaxation within 10 seconds.

The dramatic decrease in viscosity when illuminated by UV, together with the recovery of their properties when the UV is turned off, suggest several applications for these thiol-ene polymers, for instance as photo-bondable (and debondable) adhesives, UV-directed damage recovery and healing, as well as in creating remoldable devices and conformable wearables.

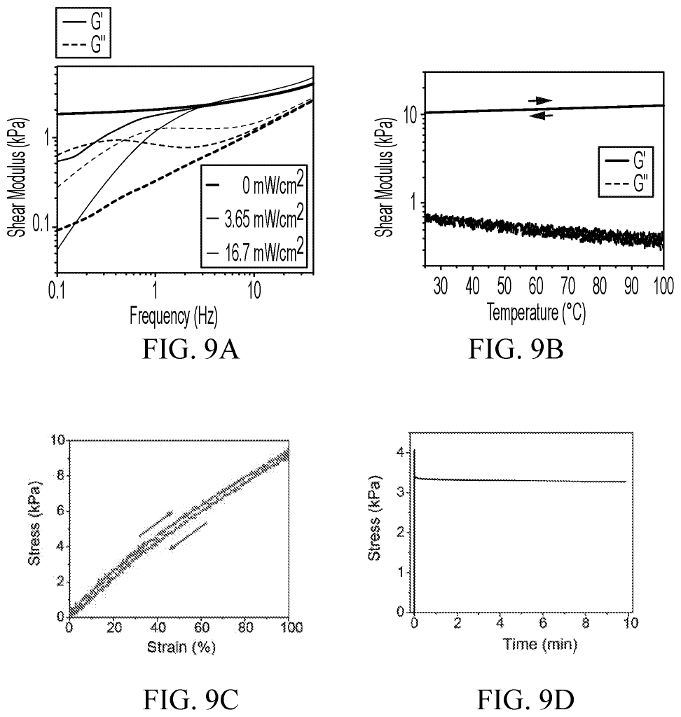

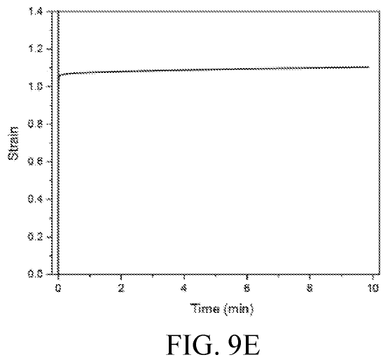

One of the advantages of photodynamic thiol-ene polymers is the nearly ideal entropic elasticity provided by covalent bonds in the absence of stimuli and transition to viscous melt in the presence of UV illumination. Dynamic mechanical analysis (DMA) measurements as a function of frequency confirmed the behavior of the material as a typical elastomer in the absence of UV illumination and a viscous polymer melt in the presence of UV illumination (FIG. 9A). In the absence of UV illumination, the photodynamic thiol-ene polymers exhibited minimal hysteresis and plastic deformation (FIG. 9C), minimal stress relaxation (FIG. 9D) and minimal creep (FIG. 9E). This may be attributed to the stability of covalent bonds in the absence of UV illumination.

For thermally-activated dynamic networks (e.g., disulfides, hydrogen bonded networks, and vitrimers), mechanical properties can be sensitive to the temperature. In contrast, thiol-ene polymers showed little change in shear modulus as the temperature was increased from 25° C. to 100° C. (FIG. 9B). In comparison, systems based on disulfide bonds typically soften and start to flow in the temperature range of about 70° C., indicating that dynamic disulfides are likely not the dominating reversible reaction occurring in the thiol-ene polymers. Without wishing to be bound by a particular theory, the small increase in G′ with temperature is consistent with entropic elasticity (G′=kT/Mc), where Mc is the molecular weight between crosslinks. The stable mechanical properties of UV-induced dynamic covalent bonding in response to thermal perturbations make them appropriate for applications where thermal cycling of devices is necessary, such as thermally-activated actuators. The thermal stability of the elastomer also suggests that UV-induced thermal heating of the material may not be a major contributing factor to the switching behavior.

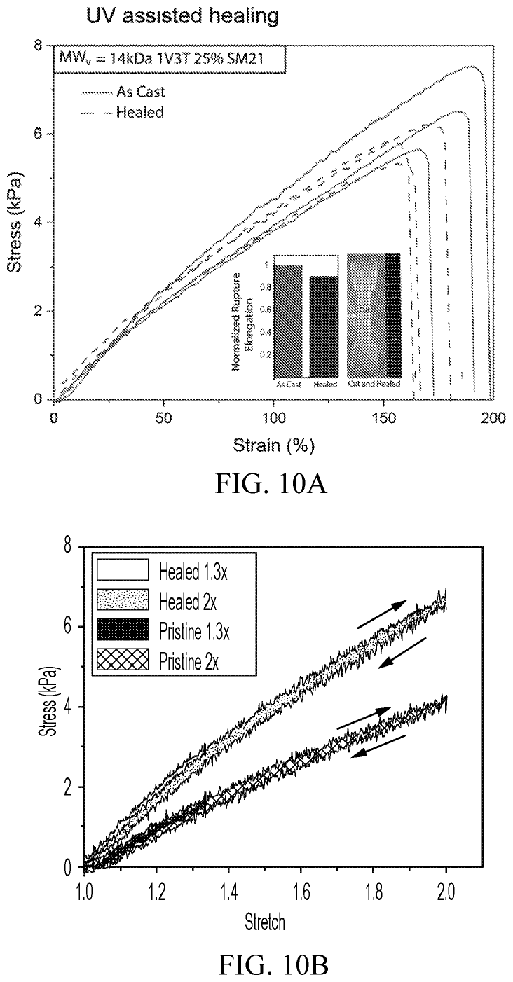

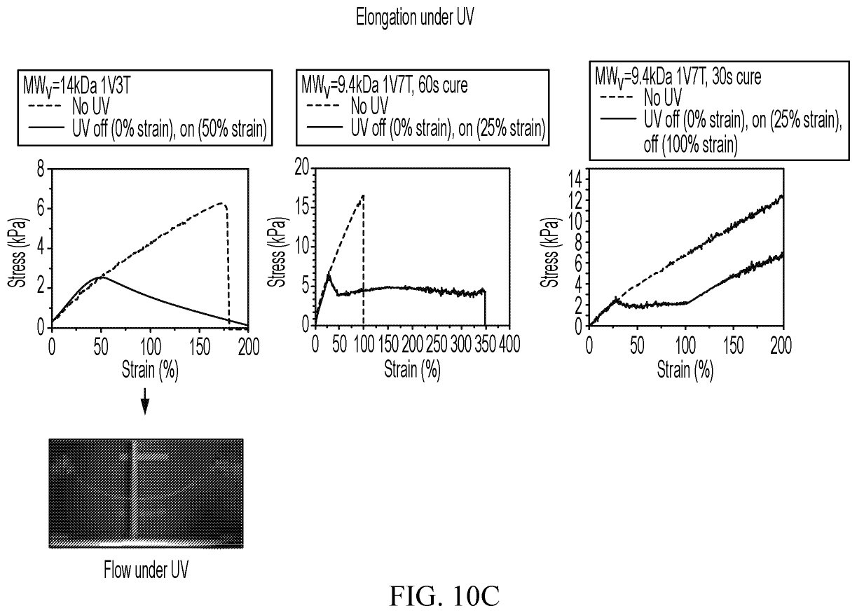

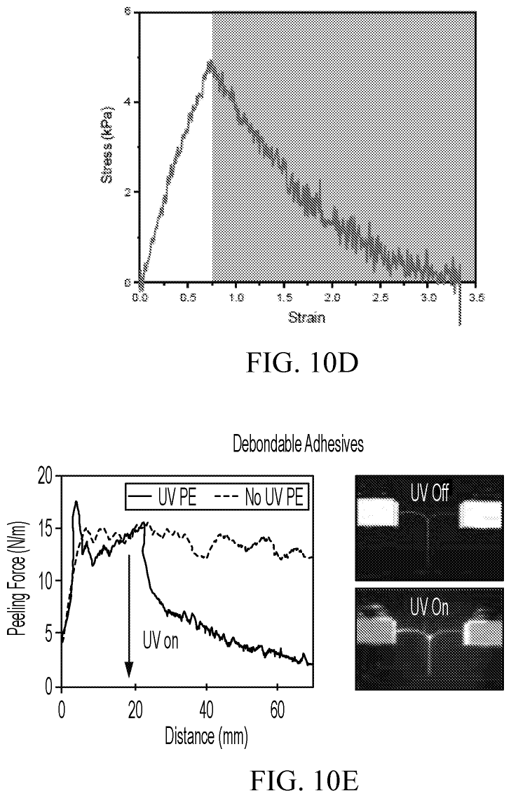

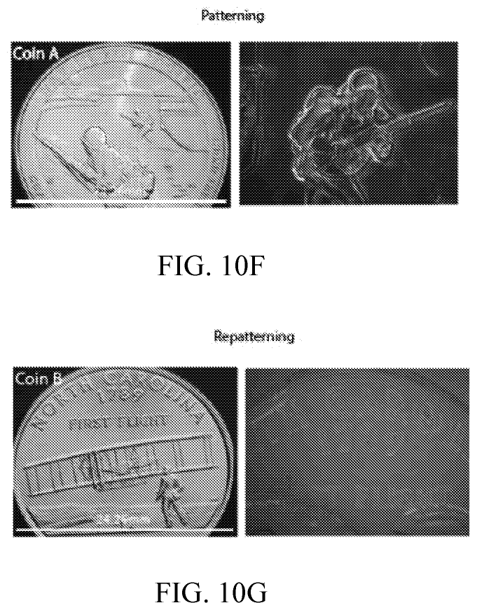

To demonstrate and quantify damage recovery and healing under UV illumination, tensile-test dog-bone samples of an optimized elastomer were cast and cured for tensile stress-strain characterization. The selected composition was a 14 kDa divinyl PDMS at 1:3 vinyl:thiol ratio with 25% of dithiol chain extenders. Under nitrogen, all samples were exposed to UV illumination (35 mW/cm²) for 150 seconds with the source 10 cm away from the sample for curing. Some samples were tested in their cast and cured state to provide reference mechanical data. Others were cut in half with a knife. The two halves were then placed in contact and exposed to the UV at full intensity for 60 seconds at 35 mW/cm² exposure. The material was observed to flow while the UV was on and heal the cut, and then solidify when the UV was turned off. The mechanical properties of these samples were then measured and compared to the as-cast samples. Tensile stress-strain curves were recorded. In all cases, the tensile tests were performed at nominal displacement rate of 1 mm/s and the load recorded with a 10 N load cell. As indicated in FIG. 10A, the load-displacement behavior of the as-cast samples and the healed samples were very similar and exhibited almost identical normalized elongation to rupture. Notably, the broken and healed samples generally failed in locations other than the initially cracked region (marked), indicating that the healed location is not always the weakest section. There was a slight increase in elastic modulus after healing, probably due to continued simultaneous curing and switching of the network. Strikingly, both the original and healed elastomer samples exhibited little or no hysteresis upon stretching to 1.3 times and 2 times (FIG. 10B). To determine the flow-stress under UV illumination, tensile test samples were stretched at a constant strain rate of 1 mm/s (FIG. 10C) and 5 mm/s (FIG. 10D) and the force measured. With no UV illumination, the stress increased as expected of an elastic material, but when the UV was turned on at 50% strain, the load dropped to zero by 200% strain. When the UV was turned off, the material became solid again. FIG. 10C shows when the thiol-ene polymer was strained under UV illumination, it elongated faster than it was being stretched, indicating that the flow stress was smaller than the gravitational force. It elongated without breaking.

Flow stress behavior can be highly dependent on material composition. Load response under constant strain was also measured for thiol-ene samples of 9.4 kDa divinyl PDMS at 1:7 vinyl:thiol ratio with only polythiols. FIG. 10C shows that thiol-ene polymers that were stretched at a constant strain rate (1 mm/s) exhibited very different stress behavior based on elastomer composition and curing conditions. Under UV illumination, stress dropped to zero, indicating flow (14 kDa, FIG. 10C, left) or remained constant (9.4 kDa, FIG. 10C, middle), indicating photo-plasticity. In the instance where stress remained constant under constant strain, as UV was turned off, the thiol-ene polymer recovered its original stress/strain behavior (9.4 kDa, FIG. 10C, right). In a demonstration of reversible adhesive, the adhesive strength of the thiol-ene polymers was reduced under UV illumination. This is illustrated in FIG. 10E, where the peeling force as a function of clamp distance was measured for a 120-μm-thick optimized PDMS layer between two layers of 20-μm-thick PE substrate film. In the absence of UV, the peeling force was almost constant with the peeling displacement (dashed line). When UV was turned on at 30 seconds, the peeling force (solid line) dropped to nearly zero. The accompanying images in FIG. 10E demonstrate viscous necking of the elastomer as it transitioned to a debondable liquid-like state under UV.

The reduced viscosity and liquid-like behavior under UV exposure provide opportunities for processing at ambient temperatures without heating. Typically, an uncured elastomer can be poured onto a surface where it flows to match the surface features, which are then imprinted onto the elastomer upon curing. For these materials, uncured viscosity and substrate feature sizes are important parameters in determining patterning. While the same pre-cure patterning can be achieved with the photodynamic elastomers in the absence of UV, post-curing patterning can also be achieved under UV. For instance, a flat, cured sheet of the optimized 9.4 kDa elastomer was placed on coin A and then illuminated. After exposure and peeling away the elastomer, it was observed to have conformed to the surface features of the coin (FIG. 10F). When repeated on a different coin, the original imprinted features were replaced by features corresponding to the new coin (FIG. 10G).

A new class of radical-induced covalent adaptive networks based on dynamic thiol-ene chemistries was demonstrated that can be implemented with a variety of polymer networks and Type I photoinitiators. Large, reversible, photoswitching from a network gel state to a liquid-like sol state was observable over a range of thiol-to-alkene moieties and molecular weights at ambient temperatures. The fast photoswitching behavior may be attributed to a dynamic covalent bonding associated with the creation of radical species under UV illumination. The transition may lead to several photo-plastic effects, including UV-induced healing of damage, large plastic deformation, and decreased viscosity. These have potential applications as debondable adhesives, remoldable elastomers, and in damage recovery for extended life applications.

### Materials and Methods

### Elastomer Preparation

Poly(ethyleneglycol-ethylenesulfide) (PEG-PES) elastomers were prepared. In brief, a divinyl component (tri(ethylene glycol) divinyl ether, Aldrich) and a dithiol component (2,2′-(Ethylenedioxy)diethanethiol), Aldrich) were combined in a stoichiometric ratio of 10:9 with 1 wt % of UV initiator Irgacure 651 (2,2-dimethoxy-2-phenylacetophenone). After UV polymerization for 10 minutes, the resulting vinyl-terminated oligomers had a molecular weight of about 3.7 kDa. These PEG-PES oligomers were combined with tetrathiols (pentaerythritol tetrakis(3-mercaptopropionate), Aldrich) at a vinyl:thiol ratio of 1:2. This ratio resulted in 5 g of 3.7 kDa PEG-PES oligomers being combined with 0.67 g of tetrathiols.

Polyurethane diacrylate (CN9028) was received from Sartomer. It was found that 0.45 g of tetrathiols in 5 g of CN9028 exhibited the photodynamic behavior depicted in FIG. 2A.

Vinyl-terminated polydimethylsiloxane (PDMS) (DMS-VXX, where XX is 05 for 0.8 kDa oligomers, 22 for 9.4 kDa oligomers, PDV for 14 kDa oligomers, and 31 for 28 kDa oligomers), polyfunctional mercaptopropyl functionalized PDMS (SMS-042), and bifunctional PDMS end-terminated with thiols (DMS-SM21) were purchased from Gelest. Irgacure 1173 (2-hydroxy-2-methyl propiophenone, HMPP) was purchased from Sigma-Aldrich. In the PDMS composition used in FIG. 2A, 0.94 g of SMS-042 and 1.06 g of DMS-SM21 were mixed together using a Thinky Mixer ARE-310 for 1 min. Vinyl-terminated PDMS was added at a 1:3 vinyl:thiol stoichiometric concentration (1.33 g) with 1 wt % photoinitiator, and mixed homogeneously at 2000 rpm for 5 minutes. After mixing, the vials were covered with aluminum foil to prevent any photoinitiator activation.

For compositions with high vinyl contents, 10 kDa PDMS end terminated with thiols (DMS-SM21 from Gelest) was combined with a vinyl-functional crosslinker (VDT-431 from Gelest) in vinyl:thiol ratios from 1:1 to 20:1.

Samples with Different Initiators

2-Methyl-4′-(methylthio)-2-morpholinopropiophenone (MMMP), Phenylbis(2,4,6-trimethylbenzoyl)phosphine oxide (BAPO), methylbenzoylformate (MBF), isopropyl thioxanthone (IPTX), and camphorquinone (CQ) were purchased from Sigma-Aldrich. 1-hydroxycyclohexyl phenyl ketone (HCPK, Irgacure 184) was not sufficiently soluble in PDMS, so it was chemically modified with PDMS. HCPK and epoxy-functionalized PDMS (DMS-E12 from Gelest) were combined in a 1:1 ratio of HCPK to epoxy groups in a vial. Chloroform was added as a cosolvent and the mixture was stirred at 50° C. for 2 days. After evaporation of the chloroform, the PDMS-modified HCPK did not show any phase separation.

Samples were prepared with a PDMS composition (4 g of 9.4 kDa divinyl PDMS, 2.82 g of polythiol PDMS, and 3.19 g of dithiol PDMS) and 60 μmol/g of initiator. 8 g of dichloromethane was then added to the composition and mixed in a speedmixer for 10 minutes to dissolve the initiator. The cap of the vial was removed, and the samples were mixed for 10 minutes to evaporate the dichloromethane.

### Photo-Rheology Measurements

The photo source used was an Omnicure Model S2000 which emitted a broad-band spectra from 250-600 nm. The Omnicure was connected to a photo-rheology attachment on a TI Discovery DHR-3 rheometer equipped with a 20 mm flat steel plate. In the photo-rheometer system, the Omnicure output an irradiance of 100 mW/cm² in the UV range (less than 400 nm). The irradiance was altered by changing the intensity of the Omnicure. Rheology measurements were conducted with a gap of 500 m. Crosslinking studies were done while measuring the rheology at an oscillation strain of 1% and frequency of 1 Hz. Stress relaxation measurements were conducted by applying 20% strain and turning on the UV light. Creep measurements (FIG. 8E) were conducted by applying a stress equal to the shear modulus of the crosslinked material. Temperature-dependent measurements were completed by crosslinking the sample for 60 s at 100 mW/cm², raising the top plate (with the sample still adhered), and replacing the photo-rheology attachment with a Peltier plate. After lowering the top plate so that sample was in contact with the Peltier plate, measurements were conducted at an oscillation strain of 1% and a frequency of 1 Hz while the temperature was ramped at a speed of 2° C./min.

### Demonstration Methods

To demonstrate and quantify damage recovery and healing under UV illumination, tensile-test dog-bone samples of an optimized elastomer (3 mm thick) were cast and cured for tensile stress-strain characterization. The selected composition was a 14 kDa divinyl PDMS at 1:3 vinyl:thiol ratio with 3:1 polythiol:dithiol ratio and 1 wt % of I1173 photoinitiators. All samples were first cured under nitrogen for 150 seconds at 35 mW/cm² UV exposure. Some samples were tested in their cast and cured state to provide reference mechanical data. Others were cut in half with a knife and then placed in contact for healing. Under nitrogen, the cut samples were exposed to broadband UV light for 60 seconds at 100% intensity with source 10 cm away from sample (35 mW/cm²). After the samples were healed, a marker indicated the place of healing. Tensile stress-strain curves were performed with the test samples in a horizontal direction. In all cases, the tensile tests were performed at a nominal displacement rate of 1 mm/s and the load was recorded with a 10 N load cell.

Elastomer samples of 9.4 kDa PDMS divinyl at 1:3 vinyl:thiol ratio with 3:1 polythiol:dithiols with 1 wt % HMPP were made to demonstrate peeling force for elastomer with and without exposure to UV. Elastomer samples (60 mm×10 mm×150 um) were cured under nitrogen for 150 seconds at 35 mW/cm² on 20 μm of polyethylene (PE) film substrate. After curing, another layer of 20 μm PE film was placed on top and UV was exposed through the top substrate for an additional 30 seconds. The peeling force as a function of clamp distance was measured using an in-house tensile setup with a 50 N load cell at a displacement rate of 1 mm/s. After 20 mm displacement, debonding under UV was measured with UV exposure 10 cm directly above the sample at 100% intensity.

Elastomer samples of 9.4 kDa PDMS divinyl at 1:3 vinyl:thiol ratio with 3:1 polythiol:dithiols at 1 wt % HMPP were made to demonstrate patterning and repatterning under UV exposure. Elastomers (1 mm thick) were cured under nitrogen for 150 seconds at 35 mW/cm² on an ITO/PET substrate. The sample was placed above a quarter-dollar coin, and UV was exposed through the ITO/PET for 60 seconds. When the elastomer was removed from the coin, microscopy showed similar features to the surface of the coin. The same elastomer sample was then placed onto another coin with different surface features. Under the same UV exposure settings, the elastomer was repatterned from one coin's features to another coin's features.

It should be understood that the features and details described above may be used, separately or together in any combination, in any of the embodiments discussed herein.

Some aspects of the present technology may be embodied as one or more methods. Acts performed as part of a method may be ordered in any suitable way. Accordingly, embodiments may be constructed in which acts may be performed in an order different than described or illustrated, which may include performing some acts simultaneously, even though they may be shown or described as sequential acts in illustrative embodiments.

Aspects described in one embodiment may be combined in any manner with aspects described in other embodiments.

Any use of ordinal terms such as “first,” “second,” “third,” etc., in the description and the claims to modify an element does not by itself connote any priority, precedence, or order of one element over another, or the temporal order in which acts of a method are performed, but is or are used merely as labels to distinguish one element or act having a certain name from another element or act having a same name (but for use of the ordinal term) to distinguish the elements or acts.

The indefinite articles “a” and “an,” as used herein in the specification and in the claims, unless clearly indicated to the contrary, should be understood to mean “at least one.”

Any use herein, in the specification and in the claims, of the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Any use herein, in the specification and in the claims, of the phrase “equal” or “the same” in reference to two values (e.g., distances, widths, etc.) should be understood to mean that two values are the same within manufacturing tolerances. Thus, two values being equal, or the same, may mean that the two values are different from one another by ±5%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. As used herein in the specification and in the claims, the term “or” should be understood to have the same meaning as “and/or” as defined above.

The terms “approximately” and “about” if used herein may be construed to mean within ±20% of a target value in some embodiments, within ±10% of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

1. A composition, comprising:
a vinyl oligomer comprising at least two vinyl groups;
a first thiol oligomer comprising at least two thiol groups; and
a Type I photoinitiator.

2. The composition of claim 1, wherein a ratio of thiol groups to vinyl groups in the composition is at least 2:1.

3. (canceled)

4. The composition of claim 1, wherein a ratio of thiol groups to vinyl groups in the composition is in a range from 3:1 to 10:1.

5. The composition of claim 1, wherein the vinyl oligomer has a number average molecular weight in a range from 0.8 kDa to 28 kDa.

6. (canceled)

7. The composition of claim 1, wherein the vinyl oligomer comprises two vinyl groups.

8. The composition of claim 1, wherein each of the at least two vinyl groups is independently an allyl, vinyl ether, or acrylate group.

9. The composition of claim 1, wherein the first thiol oligomer comprises at least three thiol groups.

10. The composition of claim 1, further comprising a second thiol oligomer comprising at least two thiol groups.

11. The composition of claim 10, wherein the first thiol oligomer comprises a greater number of thiol groups than the second thiol oligomer, and wherein a ratio of the first thiol oligomer to the second thiol oligomer is at least 3:1.

12-14. (canceled)

15. The composition of claim 1, wherein the composition comprises a ratio of thiol to vinyl groups in a range from 2:1 to 10:1 and a ratio of a number average molecular weight of the vinyl oligomer to a number average molecular weight of the first thiol oligomer of the polymeric composition in a range from 1:10 to 2:1.

16. The composition of claim 1, wherein the photoinitiator comprises 2-hydroxy-2-methyl propiophenone (HMPP), 1-hydroxycyclohexyl phenyl ketone (HCPK), 2-methyl-4′-(methylthio)-2-morpholinopropiophenone (MMMP), phenylbis(2,4,6-trimethylbenzoyl) phosphine oxide (BAPO), or 2,2-dimethoxy-2-phenylacetophenone (DMPA).

17. The composition of claim 1, wherein the composition comprises at least 60 μmol/cm³ of the photoinitiator.

18-23. (canceled)

24. A method, comprising:
exposing a composition comprising a vinyl oligomer comprising at least two vinyl groups, a first thiol oligomer comprising at least two thiol groups, and a Type I photoinitiator to an amount of electromagnetic radiation over a first period of time, wherein at least a portion of the composition is in a liquid state during at least a portion of the first period of time; and
not exposing the composition to the amount of electromagnetic radiation over a second period of time, wherein the composition is in a solid state during at least a portion of the second period of time.

25. The method of claim 24, wherein the amount of electromagnetic radiation is about 1 J/cm² or less.

26. (canceled)

27. The method of claim 24, wherein the composition in the liquid state undergoes a decrease in normalized stress of at least 80% relative to the composition in the solid state.

28-31. (canceled)

32. The method of claim 24, comprising at least 10 cycles of exposing and not exposing steps.

33. The method of claim 24, wherein the first period of time and/or the second period of time is about 60 seconds or less.

34. The method of claim 24, further comprising adding an amount of the photoinitiator after one or more cycles of exposing and not exposing steps.

35. A method of forming a thiol-ene polymeric composition, comprising:
mixing a vinyl oligomer, a first thiol oligomer, and a Type I photoinitiator to form a mixture; and
exposing the mixture to an amount of ultraviolet radiation for a period of time to form a cured mixture.

36. The method of claim 35, wherein the ultraviolet radiation has a wavelength in a range from 100 nm to 400 nm.
